(19) United States
(12) Patent Application Publication
(10) Pub. No.: US 2010/0017323 A1
(43) Pub. Date: Jan. 21, 2010

(54) Method and System for Trading Combinations of Financial Instruments

(75) Inventor: Jason Arthur Zimmerman, Toronto (CA)

Correspondence Address: Jason Zimmerman, 704-59 Spadina Road, Toronto, M5R 2T2, omitted

(73) Assignee: Carla Git Ying Wong, Toronto (CA)

(21) Appl. No.: 12/503,494

(22) Filed: Jul. 15, 2009

Related U.S. Application Data
(60) Provisional application No. 61/081,187, filed on Jul. 16, 2008.

(51) Int. Cl. G06Q 40/00

(52) U.S. Cl. 705/37

(57) ABSTRACT

A method and system are provided for obtaining and matching single leg and multi-leg orders to trade combinations of financial instruments included in a set of two or more selected financial instruments. In preferred embodiments, orders are received during a selected time period and eligible orders are processed with a combinatorial matching algorithm that is not constrained by limit prices. All embodiments have the advantages that matched multi-leg orders can be executed with no bid/offer spread on any of their legs, there is no risk that some legs of a multi-leg order execute while others do not execute, and said embodiments can be implemented by selecting two or more existing financial instruments without requiring the creation of any special financial instrument representing a multi-leg strategy.

### CROSS-REFERENCE TO RELATED APPLICATIONS

This application claims the priority of U.S. Provisional Patent Application No. 61081187, titled “Method and System for Trading Combinations of Financial Instruments”, and filed on Jul. 16, 2008.

### BACKGROUND OF THE INVENTION

In recent years, there has been an enormous increase in the volume of electronic trading of financial instruments such as stocks, futures, options, bonds, warrants, currency pairs, and more generally securities, derivatives, swaps, and other financial instruments. Financial instruments can be traded electronically through venues which include regulated exchanges, less regulated over-the-counter (OTC) markets, and alternative trading systems such as electronic communications networks or crossing networks.

Most electronic trading occurs via orders to trade a single financial instrument; however, demand for the ability to electronically and simultaneously trade multiple financial instruments is increasing due to a variety of complex trading techniques which include portfolio optimization, portfolio liquidation, risk management, spread trading strategies, and sophisticated options trading strategies.

In typical electronic trading implementations, a trading account is created for an authorized market participant (trader) after which the trader may then place orders directly or indirectly through a software platform that allows access to numerous financial instruments available for trading at one or more venues. Such a software platform may run on a computer belonging to a trader, a brokerage, an exchange, a bank, a futures clearing merchant, a member of an exchange, or other relevant entity. A brokerage, a futures clearing merchant, a member of an exchange, or any other such entity, as well as a computer or automated trading algorithm, may also be considered a trader in some situations.

In most trading venues, a single leg order is a directive from a trader to either buy or sell a positive integer quantity (the order quantity) of a single financial instrument, whereas a multi-leg order may be viewed as a collection of two or more single leg orders (legs), corresponding to distinct financial instruments, that are meant to be executed simultaneously. A multi-leg order is defined to be in standard form if it further specifies an order quantity and the greatest common divisor (GCD) of the quantities specified by the legs of the order (the leg quantities) is equal to one, which means each financial instrument specified by a respective leg of said order is to be traded in a respective quantity equal to the order quantity multiplied by the respective leg quantity; any multi-leg order can be reduced to standard form, and it is assumed hereafter that all orders are in standard form. (For a single leg order, define the standard form to be the order quantity together with a leg quantity equal to one.) A combination order is defined to be either a single leg order or a multi-leg order, so that a collection of combination orders could include both single and multi-leg orders.

Any order will almost always include other pertinent information such as execution type (e.g. market, limit, stop, conditional, all or none), limit price, time in force (e.g. day, good until cancelled, expiration date or time, conditional), order ticket number, or other information. A single leg limit order to buy or sell a financial instrument specifies a maximum price (bid) or minimum price (offer), respectively, per unit quantity of the financial instrument at which the order may be executed; such a price is called the limit price of the order and is a non-negative number. A multi-leg order may also specify a limit price for the order, which is either the maximum or minimum price per unit order quantity that may be paid or received, respectively, to execute the order; this limit price is a non-negative number. Multi-leg orders normally do not specify individual limit prices for each leg.

A quantity of an order is executed if the trades specified by the legs of the order were conducted in quantities obtained by multiplying the leg quantities by said quantity. For example, if a multi-leg order has two legs, specifies an order quantity of five, has first leg specifying to buy one of a particular futures, has second leg specifying to sell two options on said particular futures, and if a quantity equal to two of said multi-leg order was executed, then the following trades were made on behalf of the trader that placed said multi-leg order: two of said particular futures were bought, four of said options on said particular futures were sold. The quantity of an order that is executed is referred to as the quantity of the order filled. An order is defined to be executed in whole or in part if a quantity of the order is executed that is equal to or less than the order quantity, respectively. If an order was executed in part, then it is referred to as having been partially filled, and the execution of the order in part is called a partial fill. An order of the all or none execution type may only be executed in whole. For the remainder of this section, only orders executed in whole are discussed, although it should be understood that the same discussion, with appropriate modifications, also applies in respect of partially filled orders.

The execution price of an executed order is the average price per unit order quantity at which the order was executed, and this price is usually defined to be a non-negative number. Apart from an execution price, an executed multi-leg order also has a respective execution price for each leg which will be referred to as the leg execution price and is the average price at which the leg was executed. The execution price for a multi-leg order can be determined as follows. For each leg of the order, multiply the respective leg quantity by the respective leg execution price to obtain a respective first result; if the leg specifies to buy or sell a financial instrument then multiply the first result by 1 or −1, respectively, to obtain a respective second result. Sum all the second results corresponding to the legs of the order to obtain a third result, then take the absolute value of the third result to obtain the execution price. If the third result is positive or negative then the execution price is the price per unit order quantity that was paid or received, respectively, to execute the order.

A multi-leg strategy is a trading strategy that can be realized by executing a multi-leg order. Multi-leg strategies are particularly useful to options traders as a means to trade options strategies on a single underlying financial instrument such as a stock or on multiple underlying financial instruments such as a series of futures on a single commodity, index, or currency pair. Options strategies include spreads, condors, butterflies, straddles, strangles, collars, and many more.

It may be the case that a trader does not deal directly with the electronic trading venue, but instead deals with a third party or computer system(s) operated by said third party (herein called a “special access member”), such as a brokerage or futures clearing merchant, that deals with the trading venue on behalf of the trader, other traders, and possibly other parties. The trader may also communicate information with the venue through a third party access provider (or their computer system(s)) such as an independent order routing or back end service provider. The sender of an order is the party with which the trading venue deals in respect of the order. Thus, to each order is associated a respective trader, a respective sender, and a respective trading account. A trader may have several different trading accounts, especially if the trader is a bank, corporation, hedge fund, market maker, or other institution.

Most major electronic trading venues operate so as to facilitate the process of price discovery on a real-time basis. In respect of a financial instrument, price discovery refers to the process by which single leg limit orders are received and stored in an order book, and the highest bid and lowest offer disseminated to traders on a real-time basis. Such orders are executed by a matching algorithm when it becomes possible to match buy orders with corresponding sell orders, whereupon the executed orders are removed from the order book and the corresponding trades recorded. The standard matching process is conducted in real-time using a price-time priority basis: priority is first given to the highest bid and lowest offer, with ties resolved by giving priority to the earliest order.

In the case of limit orders, a limit order to buy is matched with a limit order to sell if and only if the bid is greater than or equal to the offer. A market order to buy or sell executes as soon as possible at the lowest available offer (best offer) or highest available bid (best bid) respectively. The difference between the best bid and best offer is referred to as the bid/offer spread. An order matched by the matching algorithm is considered executed (at least from a legal standpoint) and the respective trades made so that the resulting respective positions are ultimately assigned to the respective trading account and the appropriate funds debited or credited from said respective trading account (such setling of trades is often tentatively accomplished almost instantaneously in many electronic trading implementations).

In venues facilitating the process of price discovery, executing multi-leg orders presents significant technical challenges. If a multi-leg order specifies a limit price, then the individual legs of the order cannot be entered as single leg limit orders in the corresponding order books otherwise some legs might execute while other legs might not execute. Thus the broker, exchange, matching algorithm or other entity or system responsible for executing the order must monitor bids and offers corresponding to the legs of the order and use the bids and offers to compute potential execution prices for the order. Even if a potential execution price is found that would satisfy the limit price constraint of the order, it is difficult to guarantee execution of all legs of the order at the prices that were used to obtain the potential execution price, especially if the legs of the order must trade in different venues. If a multi-leg order is a market order, it is much easier to execute the legs of the order almost simultaneously; however, this would require the trader that placed the order to assume the cost associated with the bid/offer spread on every leg. In cases where a leg of such an order specifies a less liquid financial instrument, the bid/offer spread may be quite large and market execution of the leg could well result in a very unfavorable trade. The cost of bid/offer spreads is particularly prohibitive to the execution of complex options strategies that involve simultaneous purchases and sales of significant numbers of options across numerous legs.

Attempts to address such challenges have employed techniques that include: disseminating information on existing multi-leg orders to traders and waiting for responses from other traders, if any, interested in taking opposite sides of the existing multi-leg orders; executing the legs of multi-leg orders at national best bid and offers; and creating new financial instruments consisting of selected multi-leg strategies and offering single leg trading in the new financial instruments, The first technique depends on the existence of a counterparty willing to assume positions corresponding to the exact opposite of the order. The second technique requires traders to absorb the cost of the bid/offer spreads associated with the legs of an order. Unless the number of financial instruments available for trading via combination orders is quite small, then due to the problem of combinatorial explosion the third technique is necessarily restricted to a very small number of strategies as compared with the range of available multi-leg strategies. For example, selecting from just 10 financial instruments provides 2¹⁰−11=1013 possible combinations of two or more financial instruments and many more possible multi-leg strategies even if the leg quantities associated with a multi-leg strategy are restricted to taking values less than 4.

The current inventor is not aware of any method or system for trading combinations of financial instruments that has essentially all the following advantages:
(i) the method or system allows application of combinatorial matching techniques;
(ii) matched multi-leg orders can be executed with no bid/offer spread cost on any of their legs;
(iii) there is no risk that some legs of a multi-leg order execute while others do not execute;
(iv) and advantages (i), (ii), and (iii) can be achieved without requiring the creation of new financial instruments consisting of selected multi-leg strategies and the offering of single leg trading in the new financial instruments.

Thus there is a need in the art for a method and system for trading combinations of financial instruments having essentially all of the afore-mentioned advantages (i), (ii), (iii), and (iv).

### BRIEF SUMMARY OF THE INVENTION

The present invention is directed to methods and systems that satisfy the aforesaid need. Some embodiments and optional features of said embodiments are summarized in this section. Conventions and definitions of some terms and phrases used, but not defined, in this summary section can be found in the background section above or the detailed description section below.

The term “embodiment” means “embodiment of the invention”. An “optional feature” of a particular embodiment is also an embodiment that has all of the characteristics of said particular embodiment as well as one or more additional (distinguishing) characteristics. Each statement of an embodiment is to be considered independent of any other statement of an embodiment despite any use of similar or identical language characterizing each embodiment. For example, where an embodiment is identified as “another embodiment”, the identified embodiment is independent of any other embodiments characterized by the term “another embodiment” unless preceded by the term “said”.

In one embodiment, a method of trading combinations of financial instruments is provided. Combination orders to trade financial instruments are obtained by receiving such orders during a first selected time period. The received orders that are eligible for matching are stored and the corresponding expanded eligible orders are processed by a combinatorial matching algorithm (CMA) beginning at a selected time. The output of said CMA is a matched collection of expanded eligible orders that the operator of the embodiment may consider to be executed. Eligibility is prescribed by requiring an eligible order to satisfy at least one selected condition. The preceding sentence should be interpreted as meaning that an order is eligible if. said order satisfies all conditions in a non-empty group of selected necessary conditions, wherein said group includes the condition that all the financial instruments specified by the legs of an eligible order must be in a set of two or more financial instruments that have been selected to be made available for trading; and, optionally, said order satisfies at least m conditions among n selected non-necessary conditions, wherein n is an integer greater than or equal to one, wherein m is an integer greater than or equal to one, m is less than n, and said at least m conditions may be any combination of said n selected non-necessary conditions.

Optional features of said one embodiment include receiving a respective price per unit for each financial instrument in said set, wherein said CMA satisfies one of the following conditions: said CMA is not constrained by limit prices and said each financial instrument may not be traded at a price per unit other than said respective price; and said CMA is constrained by limit prices and uses the received prices to determine if a collection of expanded eligible orders containing limit orders is a matching collection satisfying the limit price constraints of said orders.

In another embodiment, having all of the characteristics of said one embodiment, said CMA is based on an algorithm that solves a selected matching problem that is linear, where the latter problem can be represented as a 0-1 integer programming problem (which is an NP-complete problem), and wherein said algorithm is an algorithm that solves an integer programming problem.

An optional feature of said another embodiment includes an embodiment for which the matching score for each expanded eligible order equals the sum of the generalized leg quantities. Thus, said optional feature makes said selected matching problem equivalent to the problem of maximizing the total number of financial instruments traded, whereby the latter problem is equivalent to the problem of maximizing commission fees for the operator of said method if said operator charged a fixed commission fee per trade per unit of a financial instrument.

Another optional feature of said another embodiment includes an embodiment for which the matching score of each selected expanded eligible order is equal to one and the matching score for an expanded eligible order that is not selected is equal to zero, and a further feature is such that all expanded eligible orders are selected. Thus, said another optional feature makes said selected matching problem equivalent to the problem of maximizing the number of expanded eligible orders matched, whereby the latter problem is equivalent to the problem of maximizing the total number of fills for eligible orders.

Yet another optional feature of said one embodiment is obtained by requiring each financial instrument in said set to one of the following: a respective derivative; a respective stock; a respective futures contract; a respective currency pair; and a respective option; whereby an operator of an embodiment could make any combination of derivatives, stocks, futures, currency pairs, or options available for combination trading.

A further embodiment comprises computer-executable software code, transmitted as an information signal, for causing a computer to implement the steps of said method.

Another embodiment comprises a computer-readable medium having computer-executable instructions stored thereon for causing a computer to implement the steps of said method.

In yet another embodiment, a computer-based system for trading combinations of financial instruments is provided. Said yet another embodiment comprises means for obtaining combination orders to trade financial instruments and means for obtaining a matched collection of expanded eligible orders. Eligibility is prescribed in the same manner as in said one embodiment. Said system includes hardware or software operative to implement any of the steps, acts, or other characteristics of an embodiment or a method described herein. Optional features of said yet another embodiment include one of the following: means and steps for providing additional trading functionality; and means and steps for increasing (at least in principle) the quality of said matched collection. Said yet another embodiment and said optional features are further described in the detailed description section below.

In a preferred embodiment, having all of the characteristics of said one embodiment, said method further comprises accepting, during said first selected time period, modification orders, wherein each such modification order is a directive from a sender to either cancel or to both cancel and replace a prior order that was received from said sender, further comprises informing the respective sender or the respective trader associated with each eligible order of the respective quantity of said each eligible order filled, further comprises providing information on the state of said processing to at least one market maker for said method, further comprises receiving zero or more combination orders to trade financial instruments from said at least one market maker during a second selected time period, further comprises determining whether to accept a received combination order from said market maker as an eligible order, wherein said CMA is the preferred CMA, wherein said preferred CMA solves a linear selected matching problem, wherein the matching score for any expanded eligible order is equal to one, wherein said selected time follows the conclusion of said first selected time period, wherein the number of financial instruments in said set is less than a first selected number, and wherein said at least one selected condition includes all of the following necessary conditions: the order quantity of an eligible order multiplied by the sum of the leg quantities of said eligible order is less than or equal to a second selected number, the number of legs of an eligible order is less than or equal to a third selected number, each leg quantity of an eligible order is less than or equal to a fourth selected number, an eligible order must allow partial fills, and an eligible order must not specify a limit price.

An advantageous practical application of said preferred embodiment involves supplementing trading at established venues. Most exchanges and other entities operating electronic and manual trading markets for financial instruments determine closing, settlement or other fair market prices of the financial instruments after the close of regular trading on each trading day in order to provide traders, brokerages, other relevant entities or the public in general with official prices of the financial instruments at the close of regular trading. Such prices are referred to herein as daily mark to market (DMTM) prices, and they are usually determined according to published rules or standards. Brokerages, clearing firms, exchanges, and other entities that have authorized traders to trade in such markets via trading accounts use DMTM prices to determine margin requirements of traders' portfolios, make margin calls to a trader whose trading account falls below current margin requirements, and issue daily trading account statements to traders. Traders use DMTM prices to monitor their portfolios and margin requirements, and to craft strategies.

Said preferred embodiment would be particularly advantageous if implemented to accept combination orders whose legs are included in a set of financial instruments consisting of a selected stock together with selected options on said selected stock or consisting of selected futures on a selected underlying financial instrument together with selected options on said selected futures; wherein said combination orders are accepted each regular trading day for a brief time period after DMTM prices on said set of financial instruments are determined and, optionally, disseminated to market participants; and wherein the DMTM prices would be used to clear and setle all trades resulting from executing matched orders. Such a method, or system having means for implementing said method, would appeal to many traders desiring to trade at DMTM prices, including those wanting to: liquidate positions or portfolios at DMTM prices; optimize their portfolios at DMTM prices; trade complex options strategies without costs associated with bid/offer spreads; offset risk acquired through the trading day, particularly if the trader is a market maker for an options market.

Apart from the afore-mentioned advantages (i), (ii), (iii), and (iv), which are common to every described embodiment herein, reference throughout this specification to features, advantages, or similar language does not imply that all of the features and advantages that may be realized with the present invention are or should be in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but does not necessarily, refer to the same embodiment.

Furthermore, the described features, advantages, and characteristics of the invention may be combined in any suitable manner in one or more embodiments. One skilled in the relevant art will recognize that the invention can be practiced in embodiments with or without one or more of the specific features or advantages of a particular embodiment. In other instances, additional features and advantages may be recognized in certain embodiments that may not be present in all embodiments of the invention.

These and other features, aspects, and advantages of the present invention will become better understood with regard to the following description, appended claims and accompanying drawings, or may be learned by the practice of an embodiment of the invention as set forth herein.

### BRIEF DESCRIPTION OF THE DRAWINGS

FIG. 1 depicts a preferred trading environment or system for implementing embodiments.

FIG. 2 depicts a flowchart for a forward matching algorithm.

FIG. 3 depicts a flowchart for a reverse elimination algorithm.

FIG. 4 depicts a flowchart for a preferred priority elimination scheme.

### DETAILED DESCRIPTION OF THE INVENTION

Although algorithm, method, or process steps may be described or claimed in a particular sequental order, there is not necessarily a requirement that such steps be performed in said sequential order; such steps may be performed in any order, or performed concurrently or simultaneously, when logically possible. Furthermore, an illustration of an algorithm, method, or process in a drawing does not imply that said illustration should be interpreted as exclusive of non-illustrated variations or modifications of said algorithm, method, or process. Definitions and Explanations of Terms, Phrases and Conventions Used Herein

For convenience, before further description of the invention, certain terms, phrases and conventions employed in the specification, drawings, examples, and appended claims are collected and elucidated in this subsection. Terms, phrases and conventions already defined or explained in the background section have their meanings extended to the context of the invention, when appropriate or logically possible. Unless defined or explained otherwise, all mathematical, scientific, and technical terms, phrases, conventions, and notations used herein have the same meaning as commonly understood by those of ordinary skill in the art to which this invention belongs.

The term “herein” means “in this patent application”.

The term “e.g.” means “such as” which means “for example” and is not intended to be limiting.

The term “claim” refers to a claim in the appended claims. A claim may describe more than one embodiment of the invention.

The term “characteristic” means a distinguishing trait, quality, or property, and is to be interpreted in a broad sense; e.g. a step or act of a method is a characteristic of said method.

The phrase “in the art” refers to any art pertinent to the invention and to the context in which said phrase in used; said phrase may refer to more than one art.

The terms “including”, “comprising” and variants thereof mean “including but not limited to” except when immediately followed by the phrase “and limited to”, whereas the term “consisting” and variants thereof mean “including and limited to”. Example: “A function depending only on numbers, wherein said numbers include the following: 1, 2, and 3” means that said function depends on the numbers 1, 2, and 3, and may, but not necessarily, depend on other numbers.

The meaning of the term “random” encompasses both “truly random” and “pseudorandom”, where the latter term refers to something that is ultimately deterministic but that appears to be truly random, and where the phrase “appears to be” was used in a broad sense and is not limited to meaning that “pseudorandom” must satisfy one or more statistical tests for randomness. For example, a computer-implemented algorithm may make a pseudorandom choice based on information pertaining to the state of the computer on which the algorithm is running, but such a choice may not satisfy any particular statistical test for randomness.

The term “exchange” means any regulated exchange, loosely regulated exchange, non-regulated exchange, or other institution that provides a forum or venue, or operates a market where financial instruments can be bought and sold; the term “exchange can also apply to the forum or venue.

The term “operator” refers to the party (or a plurality of parties) that is implementing or operating one or more embodiments. Examples of said party include: an individual, an exchange, a bank, a brokerage, a corporation, a futures clearing merchant, a member of an exchange, and a consortium.

The term “user” refers to any party using or implementing an embodiment, and may also be used to refer to a user's computer system(s). Examples of said party include: a trader, a brokerage, an exchange, a futures clearing merchant, a bank, and an operator.

The term “computer-implemented method” means a method that is performed, at least in part, by: a computer, a computing device, or an electronic device.

In the summary section, drawings, this detailed description section, and the appended claims, the term “order”, without being preceded by either “combination” or “modification”, means “combination order” unless expressly stated otherwise.

If the phrase “means for” or the phrase “step for” occurs in a claim, then 35 U.S.C. sctn. 112, paragraph 6, applies to said claim. If neither the phrase “means for” nor the phrase “step for” occurs in a claim, then 35 U.S.C. sctn. 112, paragraph 6 should not apply to said claim.

In the phrases “first selected time period” and “second selected time period”, the adjectives “first” and “second” are used merely to indicate the existence of two selected time periods that could either be the same, different, or different but overlapping. The use of said adjectives should not be interpreted as requiring any chronological order in which the time periods are selected, nor interpreted as requiring any chronological relationship between said selected time periods, unless expressly stated otherwise. Similarly, the phrases “first selected number”, “second selected number”, and “third selected number” are to be interpreted in an analogous fashion.

The phrase “based on” describes both “based at least on” and “based only on” unless expressly stated otherwise. The phrases “based at least on” and “based at least in part on” have equivalent meaning. For example, the statement “If an algorithm is based on the branch and cut technique, then said algorithm is also based on the branch and bound technique” is a true statement because branch and cut is a hybrid of two techniques (with minor modifications): branch and bound; and cutting planes.

The term “determining” and any variant thereof is used in a broad sense to encompass a wide variety of actions that include calculating, comparing, computing, deriving, establishing, estimating, processing, resolving, and the like. The term “determining” does not necessarily imply that any algorithm, mathematical process, numerical method, or any particular device must be used.

The term “obtaining” and any variant thereof is used in a broad sense to encompass a wide variety of possibilities that include accepting, accessing, acquiring, determining, downloading, receiving, retrieving, and the like. The term “obtaining” does not necessarily imply that any algorithm, mathematical process, numerical method, or any particular device must be used.

The phrase “one of the following” means “at least one of the following” unless the phrase is immediately preceded by the term “exactly”; the meaning of the phrase “exactly one of the following” is the usual mutually exclusive meaning. Thus, some examples are: “exactly one of the following: A, and B” means “precisely one of these two possibilities: A and not B, and B and not A”; and “based on one of the following: A, and B” means “based on exactly one of the following: A and not B, B and not A, and A and B”.

The term “or” is to be interpreted in the non-exclusive sense unless used in conjunction with the term “either”, except where such interpretation would be offensive to reason. Thus, some examples are: “A or B” means “one of the following: A, and B”; “either A, B, or C” means “exactly one of the following: A, B, and C”; and “two or more” can only mean “either two or more”.

The term “enumeration” refers to a listing of things where the order of things as they appear in said listing is not important. A thing in an enumeration will be called an “element” and may itself be an enumeration, collection, or set if it would be cumbersome or impossible to separately enumerate. For example, if A is a collection equal to {7,9,8,6}, and B is an enumeration equal to “4,2, and 3”, then the phrase “one of the following: A, and B” is equivalent to the phrase “one of the following: 2,3,4,6,7,8, and 9”. It should be remarked that the comma in “one of the following: A, and B” was deliberate and represents a convention used herein to help identify an enumeration: the elements of an enumeration are always separated by commas (or semi-colons) even if the enumeration contains only two elements, and the term “and” always precedes the last element in an enumeration. Semi-colons are used to separate the elements of an enumeration if such usage helps clarify the enumeration.

The term “respective” essentially means “taken individually” and is used in conjunction with the term “each” to signify that the object qualified by “respective” depends on the particular instance of the other object following “each”. Some examples are: “a respective number for each financial instrument in a set” means a number is associated with each financial instrument in said set such that the numbers associated with any two distinct financial instruments could be different; “a number for each financial instrument in a set” means the same number is associated with every financial instrument in said set.

In the definitions that follow, let i, m and n denote positive integers respective to each definition.

The term “collection” means an aggregation of objects considered as a whole (which may contain multiple instances of a particular object), thus “collection” has essentially the same meaning as the term “multiset” in mathematics; an object in a collection is a “member” of said collection. In general, the possibility that a collection is empty is allowed unless expressly stated otherwise. The “size” of a collection C is the number of members of C, where said number will be written as SIZE(C). An example of a collection is {2,3,5,3,1}, where the use of curly braces signifies that the collection is unordered. In general, a collection is unordered but an ordering (such as an index ordering) may be imposed on a non-empty collection. An index ordering means that a respective distinct index is associated with each member of a collection containing n objects, where an index is defined to be a positive integer less than or equal to n that refers to a specific member of the collection; depending on the context of usage, said index could be a fixed number (e.g. the index referring to a unique member of a collection having specific properties) or take a variety of values and be denoted by a variable (e.g. considering an arbitrary member of a collection). A member of a collection C with an index ordering is generally written with the index as subscript, such as xi for some index i. An index ordering converts a collection of n objects into an n-tuple of objects.

An “n-tuple” is an ordered list of n objects and is delimited by parentheses. A particular object in an n-tuple is called a component of the n-tuple. For example, the 5-tuple (2,3,5,3,1) can be obtained by imposing a specific index ordering on the collection {2,3,5,3,1 }: the first component (1 -component) of the 5-tuple is 2, the second component (2-component) of the 5-tuple is 3, etc. . . . An n-tuple having components that are numbers is essentially the same as a numerical vector in mathematics: n-tuples can be added together by adding their corresponding components together, and can be multiplied by a scalar number by multiplying each component by the scalar. From a linear algebraic perspective, an n-tuple may be viewed as an n-dimensional row or column vector. If x denotes an n-tuple, then xᵢ denotes the i-component of x, where i represents an index. The zero n-tuple is the n-tuple for which every component is equal to zero.

A “subcollection” S of a collection C is a collection that is contained in C such that if x is a member of S and occurs m times in S, then x must also be a member of C that occurs n times in C where m must be less than or equal to n. In general, the possibility that S is either empty or equal to C is allowed, unless the term “proper” is used to refer to S in which case S cannot be equal to C. If a subcollection S of a collection C is manipulated by adding or removing members, then it should not be assumed that said members are also added or removed from C, respectively, unless contextually obvious or expressly stated otherwise.

A “set” is a collection consisting of distinct objects (no two members are the same), and therefore “set” has essentially the same meaning as in mathematics. A “subset” A of a set S is a set that is contained in S such that if x is a member of A then x is also a member of S. The phrase “set consisting of” is abbreviated to “set of”.

The term “group” means “set” as previously defined, and thus “group” does not have the same meaning as in mathematics.

The phrase “collection of” means “collection consisting of”.

Numerical examples of collections, subcollections, sets, and n-tuples: {2,4,3,3} is the same collection as {3,2,3,4} but (2,4,3,3) is not the same 4-tuple as (3,2,3,4), {2,3,4,3} is a subcollection of {4,3,3,3,2,7}but {3,4,4} is not a subcollection of {4,3,3,3,2,7}, and {2,4,3 } is a set but {2,4,3,3 } is not a set.

The phrase “eligible order” refers to an obtained order that is eligible for matching, the phrase “eligible orders” refers to the collection consisting of every order that is an eligible order, and the phrase “expanded eligible orders” refers to the collection consisting of every order that is an expanded eligible order. Such collections may vary with time (e.g. as eligible orders are received).

A “priority ordering”, also referred to as “ordering”, on a collection is a rule, process or algorithm, for prescribing a relative priority between two considered members x and y of a collection C, that operates as follows: first determine, if necessary, whether any relative priority between said members can be prescribed according to said rule, process, or algorithm, and if so, then determining, if necessary, if the members should be prescribed the same priority (written as x=y) or different priorities, where if different priorities should be prescribed, then determining, if necessary, which member should be prescribed lower priority than another (if x has lower priority than y, or equivalently, if y has higher priority than x, then this fact will be expressed by writing x<y, where the symbol<represents the ordering prescribing lower priority to x). An ordering is required to satisfy the condition that if x has lower priority than y then x cannot have the same priority as y, nor can x have higher priority than y, and said ordering must also satisfy transitivity conditions (if x<y and y<z, then x<z, where z is another considered member of C, and if x=y and y=z then x=z); thus, an ordering is essentially the same as a partial ordering in mathematics where a partial ordering can be strict (represented with the symbol <) or non-strict (represented with the symbol <=, where x<=y means x has lower or equal priority to y). The symbols <,<=,>,>=retain the usual meaning when comparing numbers outside of the context of priority orderings. Examples of orderings include: the basic and well-known “less than” ordering on the real numbers or any subset thereof (this ordering will be termed the “supremum ordering”), that is, if x and y are real numbers then x<y if and only if x is a smaller number than y; the opposite of the supremum ordering will be called the “infimum ordering” and it means that x<y if and only if y is a smaller number than x; the phrase “standard priority ordering”, in general, refers to a priority ordering on a set of financial instruments, wherein said priority ordering associates a respective k-tuple of numbers to each considered financial instrument in said set as well as a respective ordering (either the supremum or infimum ordering) with each possible index of an k-tuple, wherein said ordering, in respect of two considered members in said set, is prescribed by first comparing the associated two k-tuples to determine the smallest index i for which the i-components of said k-tuples are not equal, and if there exists such an index i then assign a higher priority to the member having i-component of higher priority than the i-component of the other member as determined by the ordering associated with i, but if there does not exist such an index then select one of said two members at random and give higher priority (or lower priority) to the selected member. Note that orderings used in algorithms, methods, or processes may vary with time or vary with steps or iterations of said algorithm, methods, or processes.

The term “combinatorial matching algorithm”, abbreviated as “CMA”, means an algorithm that takes eligible orders or expanded eligible orders as input, and processes said input to obtain a matched collection of expanded eligible orders or a matched collection of eligible orders.

A “termination condition” for said CMA is a condition that, upon becoming satisfied, will cause said CMA to either terminate immediately, to continue for some time before terminating, or to continue until other termination conditions also become satisfied.

An “exhaustive search” is a type of search that examines as many possibilities as necessary to find an optimal solution to a given problem, and proceeds until it finds said optimal solution or halts because of a another termination condition.

An algorithm “solves” a problem if it was designed to try to find the optimal solution to said problem; however, the meaning of “solves” does not require that said algorithm must always find the optimal solution unless it is an exact algorithm.

Apart from being used to convey the obvious meaning, the term “selected” is also sometimes used to emphasize that what is selected may be selected before, during, or after a method, step or process corresponding to an embodiment is performed, particularly if said method or process is performed on a regular basis. Note that something that is selected may be selected by one or more humans or computer systems, or the operator of an embodiment; such selection may be accomplished by any desired algorithm or process determined by the operator.

The term “current” and variants thereof refer to an instant of time or to a point in the execution of an algorithm, method, or other process. Said point could be before, during, or after a step in said algorithm, method, or other process. (The term “point” refers to a state of execution of said algorithm, method, or other process rather than to an instant of time.) A collection preceded by the term “current” means it may change from step to step (or during a step) in an algorithm, method, or process.

Some particular notations and conventions for variables used hereafter are as follows. The index i is used with respect to an index ordering imposed on the set of financial instruments selected to be made available for trading. The index j is used with respect to an index ordering imposed on a collection such as a collection of orders. The variable n is used to denote the number of financial instruments in said set. Other lowercase variables are used to denote members of collections (such as orders), numbers, or order attributes of an order (such as number of legs, order quantity, etc. . . . ). Variables x, y, z are used to denote members of collections, often together with an index as subscript. Capital variables will be used to denote collections, matrices and functions; variables representing functions will be used with parentheses. Anything between such parentheses is the argument of the function; when nothing falls between such parentheses then the variable together with the parentheses is representing the function itself. Examples: T(x) denotes the value of the function To at x, and SIZE() is a function. If the argument of a function is a collection, wherein said function is not SIZE(), then this means that said function should be applied to each member of said collection and the results summed; for example, if To is a function and C is a collection with an index ordering, then T(C)=Σⱼ₌₁^{s}T(xⱼ), where xⱼ denotes a member of C and s=SIZE(C); if C is empty then T(C) is defined to be zero. The term “said” is usually not used to refer to an introduced variable, and in such a case the same variable is used. A variable is usually introduced by writing said variable after a noun, such as “a member x of C” or “a number n”; the latter phrases are equivalent to the phrases “a member of C that is equal to x” or “a number that is equal to n”, respectively. If two distinct variables are written side by side, then it is to be inferred that they are to be multiplied together; sometimes the * symbol is explicitly used to signify multiplication if such use might help clarify the presentation.

A “market maker” for an embodiment or method refers to an individual or entity authorized to receive information on the status of the processing of eligible orders, and to respond to such information by sending zero or more orders that, at least in principle, ought to increase the quality of the matched collection of orders obtained by said CMA; an example of an order that would increase the quality of the matched collection of orders would be an order that when added into the current candidate collection to get a new collection, said new collection is a matching collection.

The term “market depth information” refers to any information regarding orders corresponding to the financial instruments selected to be made available for trading. In particular, the meaning of said term encompasses, in respect of each financial instrument in said set, the number equal to the sum of all current buy quantities and the number equal to the sum of all current absolute sell quantities.

Other definitions of terms, phrases, and conventions used herein will be defined in the remainder of this section.

### Order Representations and Matching Problems

In any implementation of an embodiment, an order (combination order) to trade financial instruments must provide sufficient information to unambiguously deduce the “basic information” of the order, where said basic information is defined to be the standard form for the order and the execution type of the order (unless the implementation of an embodiment allows only one execution type which is therefore known ab initio). Thus the basic information of an order is the order quantity, leg quantities, and the basic execution type (all or none, allow partial fills). Although an order may include “other information”, which means any information that is not basic information such as information identifying the sender of the order, order ticket number, limit price, and other pertinent information, this subsection focuses mainly on the basic information of eligible orders.

If an order is eligible for matching then the respective financial instrument specified by each leg of said order must be in a set FIthat contains two or more financial instruments selected to be made available for trading. In some embodiments, an eligible order must satisfy additional necessary conditions. Suppose said set contains n financial instruments. Upon selecting an index ordering on FI (and keeping this ordering for the remainder of this section), the standard form of each order can be represented by a respective scalar (positive integer) as well as a respective n-tuple of numbers: said respective scalar is the respective order quantity, each i-component of said respective n-tuple is either equal to zero or equal to the respective leg quantity (corresponding to the financial instrument associated with index i) multiplied by either 1 if said instrument is to be bought or −1 if said instrument is to be sold. Said each i-component is equal to zero if and only if there is no respective leg quantity associated with said instrument.

Given any collection of eligible orders, it will be very convenient to consider an equivalent collection corresponding to said any collection: the collection of expanded eligible orders. This is because the basic information of an expanded eligible order can be entirely represented as an n-tuple, which allows the problem of matching orders to be expressed in a more convenient mathematical manner. If the standard form of each eligible order x is represented as described above by a respective n-tuple and a respective scalar k, then there corresponds at least one respective “expanded eligible order” to x as follows: if x is of the all or none execution type then multiply every component of said respective n-tuple by k to get another respective n-tuple that, together with the respective other information included in x, constitutes the (single) respective expanded eligible order corresponding to x; if x allows partial fills then there are k identical respective expanded eligible orders corresponding to x, wherein every such respective expanded eligible order consists of said respective n-tuple together with the respective other information included in x. The collection of expanded eligible orders consists of the expanded eligible orders corresponding to all members of said any collection. Conversely, given any collection of expanded eligible orders it is possible to reverse the above process and convert said collection into an equivalent collection of eligible orders. Thus, there is no significant difference between a collection of eligible orders and the corresponding equivalent collection of expanded eligible orders, except that the task of matching expanded eligible orders is more easily described. The i-component of an order is the i-component of its corresponding n-tuple. The components of the respective n-tuple corresponding to an expanded eligible order are called “generalized leg quantities”. The remainder of this section will focus on expanded eligible orders.

The main task common to every described embodiment of the invention is to match expanded eligible obtained combination orders (or equivalently, to match eligible obtained combination orders) to trade financial instruments. Said task is accomplished by processing the eligible orders or the expanded eligible orders with a combinatorial matching algorithm (CMA) to obtain a “matching subcollection of the collection consisting of expanded eligible obtained combination orders”; it is possible that, depending on the expanded eligible orders and said CMA, said collection is empty. The latter phrase in quotations will be abbreviated to “matched collection of expanded eligible orders” or just “matched collection”. Orders may be input to said CMA either all at once or over a time period; similarly, said CMA may output said matched collection either all at once or over a time period, or it may choose one of several matching subcollections as its output, using a subalgorithm to make the choice. The process of selecting between several matching collections for the final matching collection can be considered part of the CMA, where “final matching collection” means the operator considers the orders executed.

The meaning of the phrase “matching collection of expanded eligible orders” depends on whether or not said CMA is constrained by limit prices; let M denote said matching collection. If said CMA is not constrained by limit prices, then the meaning of said phrase is: in respect of each financial instrument that would be traded as a result of executing every order in M, the total quantity of said each financial instrument that is bought equals the total quantity of said each financial instrument that is sold. This meaning can also be succinctly expressed as an essential condition: all n-tuples corresponding to the expanded eligible orders in M sum to the zero n-tuple. If said CMA is constrained by limit prices, then the meaning of said phrase requires that said essential condition be satisfied, and also requires that the subcollection L consisting of all limit orders in M satisfy another condition based on the respective received price per unit for each financial instrument in F that would be traded as a result of executing all orders in L. To express said another condition, a few definitions will now be introduced.

For each x in L, write the respective limit price of x as LP(x), and define the “total expanded limit price” TELP(x) as follows: either let p=LP(x) if x sets an upper limit on funds to be paid in the event that x is executed, or let p=−LP(x) if x sets a lower limit on funds to be received in the event that x is executed; then if x allows partial fills define TELP(x)=p but if x is of the all or none execution type then define TELP(x)=qp, where q is the order quantity corresponding to x (thus q is also equal to the GCD of the components of the n-tuple corresponding to x). Now define the “total expanded execution price” TEEP(x) as follows: let ui be the price per unit obtained for the financial instrument corresponding to an index i (each uᵢ may be received, or equivalently, any information may be received that is sufficient to unambiguously deduce uᵢ), and let xᵢ be the i-component of x; compute TEEP(x)=Σᵢ₌₁ⁿuᵢ xᵢ. By definition of limit price, we must have TEEP(x)<=TELP(x), thus said another condition can now be expressed as: TEEP(L)<=TELP(L). Note that TEEP(x) can be either zero, positive, or negative, is derived from the received prices, and can be defined in the same way for members of M that are not in L.

For the purpose of settling trades, let M, L and ui be as above, assume TEEP(L)<=TELP(L) and suppose M is the output of said CMA, where CMA may or may not be constrained by limit prices (if said CMA is not constrained by limit prices then it may be assumed that L is empty). There are two main steps to settling trades resulting from the execution of an order x in M: assign the resulting respective positions to the respective trading account associated with x, and either crediting or debiting said trading account an appropriate amount CDA(x) of the currency in which said trades take place. CDA(x) may be viewed as equal to the sum MTEEP(x)+COMM(x), where MTEEP(x) is the “modified total expanded execution price” defined below and COMM(x)>=0 denotes the total commissions, fees, and other expenses related to order execution of x (charged by the operator, or brokerages or other third parties). If CDA(x)<0 or CDA(x)>0 then said trading account is to be credited or debited, respectively. (For convenience, it is assumed herein that every trade takes place in the same currency, but one skilled in the art will appreciate that this is not a required or limiting assumption as different currencies or prices can be easily converted into a single base currency.)

A preferred way to define MTEEP(x) will now be described as the following steps: each trade of a financial instrument corresponding to an index i may be deemed to have been executed at a per unit price equal to the afore-mentioned uᵢ, so that for each x in M that is not in L, define MTEEP(x)=TEEP(x); split the collection L into two subcollections T and T^{c}, let T consist of all y in L satisfying TELP(y)<=TEEP(y), and let TC consist of all z in L but not in T (all z in L satisfying TELP(z)>TEEP(z)); for each y in T, define MTEEP(y)=TELP(y) so that y executes at its total expanded limit price; require TEEP(L)=MTEEP(T)+MTEEP(T^{c}), and set e=TELP(L)-TEEP(L), whereby e represents the ‘extra money’ available with which to give better execution prices to the limit orders in T^{c}; for each z in T^{c}, define DTT(z)=TELP(z)−TEEP(z); and finally, define MTEEP(z)=TELP(z)−e*DTT(z)/DTT(T^{c}), whereby the amount of said extra money given to z is proportional to DTT(z). One skilled in the art will recognize many alternative ways of defining MTEEP(x) for x in L, such as: defining MTEEP(y)=TELP(y) for y in T and MTEEP(z)=TELP(z)-e/SIZE(T^{c}) for z in T^{c}; defining TT(x)=Σᵢ₌₁ⁿ|xᵢ| for x in L, which is the sum of the absolute value of each generalized leg quantity of x, and defining MTEEP(y)=TELP(y) for y in T and MTEEP(z)=TELP(z)−e*TT(z)/TT(T^{c}), whereby the amount of said extra money given to z is proportional to the number of trades resulting from the execution of z; defining MTEEP(z)=TELP(z) for z in T^{c} and distributing e amongst orders in T; defining MTEEP(x)=TELP(x) for all x in L and distributing e amongst the operator or brokerages or other third parties; and, more generally, selecting a proportion of e to give to each x in L or to each x in M. Note that, without loss of generality, it has been assumed that TC is non-empty, for otherwise each order x in T would satisfy MTEEP(x)=TEEP(x)=TELP(x) whereby x would execute as any non-limit order.

The preceding discussion shows that any CMA that is not constrained by limit prices can be converted into a CMA that is constrained by limit prices by providing said CMA with a respective received price per unit for each financial instrument in F, and by requiring that a matching collection of expanded eligible orders satisfy said another condition in addition to said essential condition. Thus any embodiment with a CMA not constrained by limit prices can be easily modified to obtain another embodiment with a CMA constrained by limit prices, having all characteristics of said any embodiment when logically possible. Hence, there is no need to further describe a CMA that is constrained by limit prices and it is assumed hereafter that any described or mentioned CMA is not constrained by limit prices.

Given a collection C of expanded eligible orders to match, the problem of finding a matching subcollection S of C can now be expressed as equivalent to the problem of finding a solution b to a linear matrix equation corresponding to C, wherein b must be in a particular format. First, choose an index ordering on C and define an “order matrix” K as follows: let the j^{th} column of K be the column vector equivalent of the n-tuple of xⱼ in C, whereby the matrix entry Kᵢⱼ is equal to the i-component of xⱼ. Then said matrix equation is written as: Kb=0, where b is a binary column vector so that each component of b is either 0 or 1; b represents the subcollection S in the sense that the j-component of b (bj) corresponds to xⱼ so that xⱼ is in S if and only if bⱼ is one, whereby Kb=0 is equivalent to said essential condition. Depending on K, it is possible that there are many solutions b of Kb=0, or it is possible that the only solution to Kb=0 is b=0 (the zero column vector) which would mean there is no matching subcollection of C or that the S corresponding to b is the empty subcollection. The number of possible subcollections of C having more than one element is 2^{SIZE(C)} SIZE(C)−land thus increases exponentially with the number of orders in C. Matrix equations such as said matrix equation can be solved with techniques used in linear algebra, examples of which are: lattice reduction, a partial or full computation of the row echelon form of an order matrix, a partial or full computation of the Smith normal form of an order matrix, and a partial or full computation of the minimal generators of an order matrix equation. Combinatorial techniques for solving such an equation are described below. Note that said index ordering is not fundamentally important in terms of possible index orderings, since any other possible choice of index ordering is necessarily a bijective permutation P() of said ordering, so that if said index ordering is changed to another index ordering corresponding to P(), then this would just result in reordering the columns of K to get another matrix J (column j of K corresponds to column P() of J) and correspondingly reordering the components of b to get another binary column vector v (bⱼ corresponds to the P(j)-component of v), whereby Kb=Jv=0, and S consists of the same orders with respect to either chosen index ordering.

The particular problem of finding a matching collection of eligible orders (without considering expanded eligible orders) can be expressed in an analogous but less convenient fashion. In this situation, an index ordering is again chosen for the collection of eligible orders; the j^{th} column of an order matrix K is the column vector equivalent of the n-tuple corresponding to eligible order xⱼ; and again, said problem is equivalent to finding solutions to the equation Kb=0, except now bⱼ is either 0 or qⱼ (qⱼ is the order quantity of xⱼ) if xⱼ is an all or none order, otherwise if xⱼ allows partial fills then bⱼ can be any non-negative integer less than or equal to qⱼ. One skilled in the art will appreciate that the combinatorial matching algorithms described herein can be modified (by making very minor changes) to accept eligible orders as input or expanded eligible orders as input, and thus obtain embodiments with matching algorithms that process eligible orders or expanded eligible orders. Hence, there is no need to further describe said particular problem and only expanded eligible orders need to be considered as input to a CMA; furthermore, the phrases “processing eligible orders” and “processing expanded eligible orders” can be viewed as having equivalent meaning.

In some embodiments, the corresponding CMA looks for a matching subcollection S of C that maximizes a real-valued function on subcollections of C. This is equivalent to looking for a solution b to Kb=0 that maximizes a real-valued function F(b): said CMA tries to find a b such that Kb=0 and for any other v such that Kv=0, F(v)<=F(b). This type of maximization problem (a combinatorial optimization problem) encompasses a wide variety of other problems involving solutions b of Kb=0, such as minimizing a real-valued function Fo (equivalent to maximizing −F(b)), and finding a solution b that makes F(b) as close as possible to a real number r (equivalent to maximizing −|F(b)-r|). One skilled in the art will recognize that other problems, which cannot be expressed as maximization problems, may also be solved using one or more embodiments when logically possible or with minor modifications to said one or more embodiments thus remaining within the scope of the invention.

Said type of maximization problem will be called a “selected matching problem”, whereby different matching problems may be selected by selecting different functions F(b). A matching collection of expanded eligible orders will be called a feasible solution, and if said collection maximizes F(b) then said collection will be called an optimal solution. It should be noted that neither a change in index ordering chosen for FI nor a change in the index ordering chosen for C fundamentally affect a selected matching problem. For example, letting P() be a bijective permutation as above, then a selected matching problem expressed as “maximize F(b) subject to Kb=0” is equivalent to the problem “maximize G(v) subject to Jv=0”, where J is related to K as above and G(v)=F(P⁻¹(v)).

If the selected function F(b) is linear, i.e. F(b)=Σⱼ₌₁^{s}pⱼbⱼ for selected matching scores pⱼ, where s=SIZE(C), said selected matching problem will be referred to as “linear”, and is a 0-1 integer programming problem (sometimes called a binary integer programming problem, a Boolean integer programming problem, or an integer linear programming problem). Given C, said matching scores can be assumed to be constants; however, said matching scores may vary with different collections C and in some embodiments are functions of the attributes of orders (e.g. pⱼ(xⱼ)=TT(xⱼ), the sum of the absolute value of each generalized leg quantity of xⱼ).

Combinatorial optimization problems and integer programming problems may be solved using algorithms or software including custom algorithms or custom software, commercially available software such as CPLEX (available from ILOG, which is now owned by IBM), or free software such as LP_solve. The CMA used in an embodiment to match orders may be based on any one or more of said custom algorithms or software. A preferred CMA to match orders is described in the Combinatorial Matching Algorithms subsection below.

The phrase “buy quantities” refers to all leg quantities of expanded eligible orders in the CCC (current candidates collection defined below) corresponding to a particular financial instrument which is to be bought, thus all buy quantities are positive integers. The phrase “sell quantities” refers to all leg quantities of expanded eligible orders in the CCC multiplied by −1 corresponding to a particular financial instrument which is to be sold, thus all sell quantities are negative integers. The phrase “absolute sell quantities” refers to positive integers obtained by taking the absolute value of the sell quantities corresponding to a particular financial instrument. For example, if the CCC consists of all expanded eligible orders, then choosing a particular row i of an order matrix (and thereby a particular financial instrument corresponding to index i), the buy quantities consist of all positive integers in row i and the sell quantities consist of all negative integers in row i.

It may be helpful to give an example of the afore-described processes. Suppose n=5, write FI={f₁,f₂,f₃,f₄, f₅}, suppose that the collection of orders eligible for matching is {o₁,o₂,o₃,o₄,o₅,o₆,o₇,o₈}, let qj denote the order quantity of order o_{j, suppose each o}ⱼ allows partial fills unless j=8 in which case o₈ is of the all or none execution type, and suppose the other basic information of oⱼ and corresponding 5-tuples multiplied by order quantities (these are expressed by an equation for oⱼ, and eo with index subscript denotes corresponding expanded eligible order(s)) are as follows:

i) o₁=eo₁=(0,1,0,1,0): q₁=1, buy 1 f₂, buy 1 f₄;

ii) o₂=eo₂=(0,−1,1,0,3): q₂=1, sell 1 f₂, buy 1 f₃, buy 3 f₅;

iii) o₃=eo₃=(0,0,0, −1,−2): q₃=1, sell 1 f₄, sell 2 f₅;

iv) o₄=eo₄=(0,0,−1,0,−1): q₄=1, sell 1 f₃, sell 1 f₅;

v) o₅=eo₅=(8,0,0,−7,0): q₅=1, buy 8 f₁, sell 7 f₄;

vi) o₆=eo₆=(−7,0,0,0,8): q₆=1, sell 7 f₁, buy 8 f₅;

vii) o₇=3(−1,0,0,7,−8), eo₇=eo₈=eo₉=(−1,0,0,7, −8): q₇=3, sell 1 f₁, buy 7 f₄, sell 8 f₅; and

viii) o₈=2(0,4,3,0,0), eo₁₀=(0,8,6,0,0): q₈=2, buy 4 f₂, buy 3 f₃.

The order matrix equation corresponding to the above choices of index orderings is as follows:

$$Kb = ( \begin{matrix}0 & 0 & 0 & 0 & 8 & - 7 & - 1 & - 1 & - 1 & 0 \\ 1 & - 1 & 0 & 0 & 0 & 0 & 0 & 0 & 0 & 8 \\ 0 & 1 & 0 & - 1 & 0 & 0 & 0 & 0 & 0 & 6 \\ 1 & 0 & - 1 & 0 & - 7 & 0 & 7 & 7 & 7 & 0 \\ 0 & 3 & - 2 & - 1 & 0 & 8 & - 8 & - 8 & - 8 & 0\end{matrix} ) b = 0$$

Thus, it is easily seen that there are only two distinct matching collections of the expanded eligible orders (taking eo₇, eo₈, and eo₉ to be identical): these are given by M₁={eo₁,eo₂,eo₃,eo₄} and M₂{eo₅,eo₆,eo₇} which correspond to the following two solutions of said order matrix equation (expressed as 10-tuples instead of 10×1 column vectors): (1,1,1,1,0,0,0,0,0,0), and (0,0,0,0,1,1,1,0,0,0). It can also be seen that M₁ (but not M₂) would be the optimal solution to the problem of maximizing the total number of expanded eligible orders filled, whereas M₂ (but not M₁) would be the optimal solution to the problem of maximizing the number of financial instruments traded (for said optimal solution, said number is 46).

Computers, Electronic devices, Standards, Protocols, and Related Hardware, Software and Operations

It will be readily apparent to those of ordinary skill within the art that any one or more embodiments, components or characteristics thereof (the various steps, acts, functions, methods, processes, systems, or algorithms) described herein may be implemented in whole or in part using a variety of suitable hardware, suitable software or combinations thereof; said hardware includes one or more appropriately programmed or configured electronic devices that include computers, computing devices, and other electronic devices, as well as computer-readable media. All operations, computers, electronic devices, media, networks, protocols, standards, and related hardware and software described in this subsection should be well-known to those of ordinary skill within the art.

For implementing any one or more of said various steps, acts, methods, processes, systems, or algorithms, numerous appropriately programmed and configured computers or electronic devices would be suitable, including one or more of the following types: desktop, notebook, laptop, mainframe, supercomputer, microcomputer, server, workstation, cellphone, smartphone, personal data assistant (PDA), multi-function machine, fax machine, scanner, copier, printer, calculator, telephone, and computer cluster (e.g. Beowulf, workstation, load balancing, high availability, Terracotta, and parallel computing). Such a computer or electronic device may be programmed by using computer-executable software obtained as an information signal or stored on a computer-readable medium. Such a computer or electronic device may be managed, used or controlled (locally or remotely) by means of one or more input, output, or display devices that are connected to the computer or the electronic device via wires or wirelessly (locally or remotely, individually or over a network); such input, output, or display devices include a keyboard, a keypad, a touchpad, a pointing device (e.g. mouse, trackball), a pen device, a console, a microphone, a speaker, a headset, an LCD monitor, a CRT monitor, an LCD projector, a touchscreen, graphics tablet, and any other input device incorporating a sensor that monitors, scans for, and accepts information from a user, as well as a computer. Such a computer or electronic device may include a processor which controls the overall operation of the computer or electronic device and a system bus that connects the processor with the main memory (e.g. RAM), possibly with another computer-readable medium or optical, floppy, or hard drive (for reading, writing, or storing files, data, software, or instructions), and possibly with one or more conventional components such as a modem, network card, network adapter, network controller, or wireless transmitter or receiver. Such a computer or electronic device may include a protective casing together with a power supply and a variety of jacks, connectors or other interface components (power supply connector, RJ-11, RJ-45, USB, IEEE 1394, PS/2 keyboard jack, PS/2 mouse jack, wireless transmitter, receiver, controller, or adapter) that can be used to connect or couple the computer to a network or input, output, or display devices. Such computers or electronic devices may be used individually or in an interconnected group over a network (e.g. direct device to device connections, LAN, WAN, intranet, extranet, and internet), and connected wirelessly or by using wires or other transmission media together with appropriate protocols such as Ethernet (IEEE 802.3), Bluetooth, VPN, Wi-Fi, DSL, ADSL, SAP, ATP, TCP/IP, IP, UDP, HTTP, FTP, SGML, XML, XHTML, HTML, SSL, GSM, TCP, TDMA, CDMA, 3G, 802.11 a/b/g/n, or any OSI layer 1,2,3,4,5,6,7 type protocol, and by using connection-related hardware including as many repeaters, receivers, transmitters, bridges, hubs, routers, switches, connectors, jacks, wires, antennas, or interfaces as required.

The phrase “computer system” refers to a computer, computing device or other electronic device together with zero or more input, output, or display devices, and possibly with a computer-readable medium or software. The term “system” encompasses any one or more computer systems, electronic devices, networks, interconnections or couplings, software, other relevant hardware, or combinations thereof. The tem “processor” means at least one microprocessor, central processing unit (CPU), or any other electronic chip or combination thereof. Types of processors include single and multi-core processors (CPU), RISC, CISC, GPU, and microprocessor; commonly used processors include those made by Intel and AMD.

The phrase “computer-executable software” refers to any type of computer-executable instructions, such as modules, software, computer program(s), code, or script(s), that can directly or indirectly (e.g. after being installed or otherwise transformed) cause a computer to perform various tasks or functions, such as implementing said various steps, methods, processes, or algorithms; said phrase is sometimes abbreviated to “software” herein, and encompasses the meaning of the phrase “computer program product”. Said instructions may be distributed on a distribution medium or via information signal or transmission media, after which they are run on a computer (thereby programming said computer); said instructions are run from said distribution medium, copied to an intermediate storage medium and run from said storage medium, or installed onto an intermediate storage medium and run from said storage medium. When said instructions are run, they load from their distribution medium or intermediate storage medium into the main execution memory of a computer (e.g. RAM) and are executed by the processor of the computer, thereby causing said computer to perform any of a wide variety of desired or required tasks or functions.

The phrase “computer-readable medium” refers to any medium, media, or combination of media that can store, facilitate communications, or provide data (e.g. data structures, computer-executable instructions) that may be read by a computer, a processor, a computing device, or like electronic device. General examples of such media include distribution media, intermediate storage media, memory, volatile media, non-volatile media, and transmission media. Distribution media include CDs, DVDs or any other optical medium, flash memory, floppy or flexible disks, magnetic tape and any other magnetic medium. Intermediate storage media include optical media, flash memory or flash drives, ROM memory, network storage, zip drives, tape drives, hard drives, hard disks or other magnetic medium. Volatile media include RAM memory (e.g. EDO, Rambus, XDR, XDR2, DRAM, DDR, DDR2, DDR3, VRAM, SDRAM, SRAM, ECC, unbuffered, buffered, registered) and any other type of volatile memory chip, stick, or cartridge. Non-volatile media include flash memory or flash drives (e.g. NOR, NAND), ROM, EAROM, EPROM, EEPROM and any other type of non-volatile memory chip, stick, or cartridge, distribution media, intermediate storage media, or other persistent memory or media. Transmission media include coaxial cables, twisted pair wires, USB cables, IEEE 1394, cables, telephone cables, satellite dishes, Ethernet cables (e.g. Cat 5, Cat 5e), T1 lines, T3 lines, and copper wires or other metallic or conducting wires including the wires that comprise a card, motherboard or system bus of a computer. Transmission media may include or convey acoustic or electromagnetic carrier waves such as those used for radio frequency (RF), microwave frequency, or infrared (IR) data communications.

If a single device or product is described herein then it is to be understood that, when logically possible, a plurality of such devices or products, in cooperation or not, may alternatively be used in place of said single device or product; hence functionality realized or possessed by a single device or product may alternatively be realized or possessed by a plurality of such devices or products. Conversely, analogous reasoning applies in respect of a plurality of devices or products described herein. Thus, for example, the phrase “a computer” means “one or more computers” except where such interpretation would be offensive to reason.

A description of an embodiment or component or characteristic thereof is likewise a description of an act, step, apparatus, system, or computer for implementing one or more embodiments in part or in whole, and is also likewise a description of software or a computer-readable medium storing software for causing one or more computers, computer systems, or systems to implement one or more embodiments in part or in whole. Embodiments may be realized, in part or in whole, in hardware, software, or a combination of software and hardware, and such realization may in a centralized manner in one computer system, or in a distributed manner across a plurality of interconnected computer systems. A typical combination of hardware and software can be a computer system running an OS (operating system) such as Windows XP, Vista, Unix, Linux, Leopard, and running other software that may be loaded, executed, or configured to control the computer system such that said computer system performs (at least in part) one or more of said various steps, acts, methods, processes, or algorithms. Such software may include an existing software platform for conducting electronic trading, adapted to implement (at least in part) aspects of the invention, or a custom software platform adapted to implement (at least in part) aspects of the invention. An exemplary system for implementing aspects of the invention will be described in the next subsection.

### Embodiments

For the purposes of promoting a thorough understanding of the principles of the invention, reference will be made to some exemplary embodiments illustrated in the drawings, and specific language will be used to describe the same. It will nevertheless be understood that no limitation of the scope of the invention is thereby intended. Any alterations and further modifications of the inventive features described or illustrated herein, and any combinations, equivalents or additional applications of the principles of the invention as described or illustrated herein, which would occur to one skilled in the relevant art and having possession of this disclosure, are to be considered within the spirit and scope of the invention.

Aspects of the present invention are preferably implemented via an environment or system that allows users to exchange information and place or modify orders via a computer system or telephone. Suitable components of said system include any computers, computer systems, systems, electronic devices, networks, standards, protocols, media, or related other hardware, software, or operations described in the preceding subsection, or their equivalents.

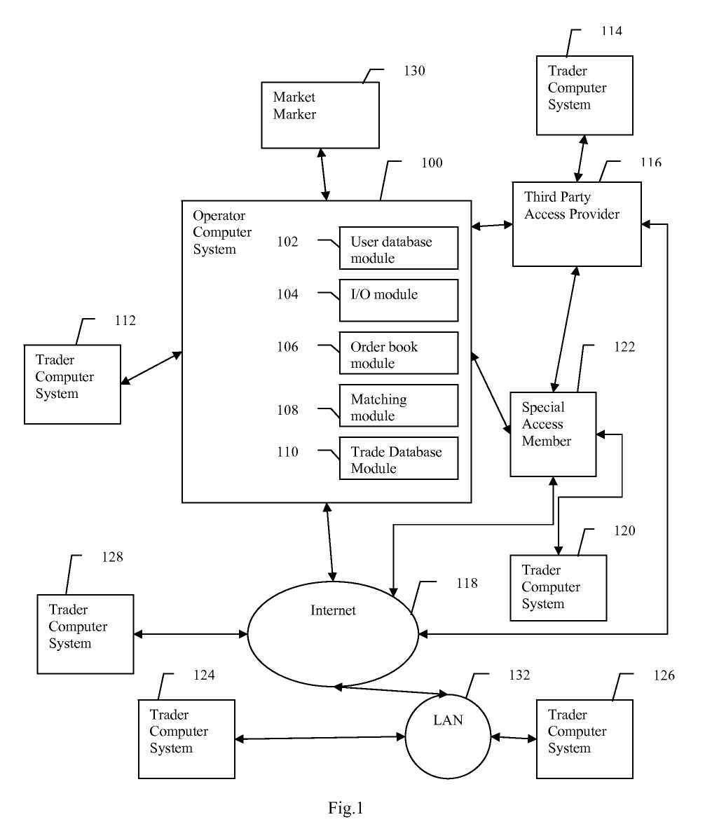

An exemplary environment or system for implementing computer-implemented methods or computer-based systems for trading combinations of financial instruments is shown in FIG. 1. Operator computer system (OCS) 100 receives or otherwise obtains orders (e.g. obtains by retrieving from a computer-readable medium or another computer system, or by downloading) and transmits data related to orders, trades, or account information to users, or otherwise exchanges information with users. OCS 100 may include software components such as: a user database module 102 for identifying traders and other users uniquely or as one or more groups, for storing or retrieving user names, passwords or other information, for using or processing user trading account information; an input/output (I/O) module 104 for receiving or otherwise obtaining orders or modification orders, for obtaining any relevant or required information, or for transmitting trading information to users (such as market depth information, price information), for notifying users of the quantity of their orders filled (said quantity could be zero), or for exchanging any other relevant information with users; an order book module 106 for determining an order's eligibility for matching (if such determination required), for storing eligible orders, and possibly for preprocessing eligible orders into a database appropriately configured to increase efficiency; a matching module 108 comprised of a combinatorial matching algorithm (CMA) that processes expanded eligible orders (or equivalently, processes eligible orders) to obtain a matched collection of expanded eligible orders; and a trade database module 110 for recording the results of the matching process, or for clearing or settling trades.

A trader computer system (TCS) 112 is shown directly connected to OCS 100. Another TCS 114 is shown indirectly connected to OCS 100 via third party access provider (TPAP) 116 (such as a back office service provider or an independent order routing service provider) which is directly connected with OCS 100 or indirectly connected with OCS 100 via the internet 118. TCS 120 is indirectly connected with OCS 100 via special access member (SAM) 122, where SAM 122 is directly connected with OCS 100 or indirectly connected with OCS 100 via TPAP 116 or via internet 118. TCS 124 and TCS 126 are indirectly connected with OCS 100 via a LAN 132 and internet 118, and TCS 128 is indirectly connected to OCS 100 via internet 118. Market maker(s) 130 for an embodiment may be kept informed of the state of the matching process so that market maker(s) 130 have the opportunity to place orders that may facilitate the matching process, such as placing an order that would enable said CMA to match all expanded eligible orders currently under consideration together with said order, or that would increase, at least in principle, the quality of the output of said CMA. The term “quality” is subjective to the operator or embodiment; in an embodiment where said CMA is to maximize the number of eligible orders filled, “quality” could be measured (or considered equivalent) to the size of the output of said CMA; in an embodiment where said CMA is to maximize the number of trades made, “quality” could be measured (or considered equivalent) to the sum of all leg quantities of all expanded eligible orders in the output of said CMA. Note that eligibility requirements for orders from market maker(s) 130 may be different from eligibility requirements for orders from other traders. Information is exchanged via connections in FIG. 1 (line segments having arrows on ends) that may realized via wires or wirelessly using transmission media, protocols, connection hardware, or other relevant hardware or software described in this application or equivalents thereof. SAM 122, TPAP 116, or market maker(s) 130 may have a computer system to exchange information (e.g. orders) with OCS 100 or any TCS. A respective trader using any TCS, SAM 122, TPAP 116, or market maker(s) 130 may also place orders or exchange information via fax or telephone, if desired or necessary.

The operation of computer systems shown in FIG. 1 (and those systems used by TPAP 116, SAM 122, and market maker(s) 130) may be controlled via software stored on a computer-readable medium. For example, each TCS may include software to allow a respective trader to place and modify orders and, more generally, to exchange information with OCS 100, SAM 122, or TPAP 116. Said software may be custom designed for implementing an embodiment, or may be comprised of existing software adapted, configured, or modified for implementing an embodiment. As another example, OCS 100 may include software incorporating modules 104, 106, 108, 110.

One skilled in the art will appreciate that the trading environment shown in FIG. 1 is an example, that the elements in FIG. 1 may be interconnected in numerous other ways, and that numerous other systems may be used and interconnected in many alternative ways. Said other systems could include clearing, fee, regulatory, or settling systems.

The selection of times, time periods, financial instruments to be made available for trading, or other things prefaced by the term “selected”, may be performed by the operator, a computer system or other system controlled or set up by the operator, and is done so in according to the manner in which said operator desires to configure an embodiment.

In an embodiment that the current inventor believes is the best mode for implementing the invention, the method corresponding to claim 21 is implemented via the trading environment or system illustrated in FIG. 1 or via a similar environment or system, preferably with many more participating traders and corresponding trader computer systems. To increase, at least in principle, the quality of the matched collection output by the preferred CMA, said embodiment requires eligible orders to allow partial fills, requires eligible orders not to specify a limit price, and imposes upper limits on: the size n of Fl, the number nl of legs an eligible order can have, the value Iq of any leg quantity an eligible order can have, and the number qls equal to the order quantity multiplied by the sum of the leg quantities. The preferred CMA corresponding to claim 21 will be described in the next subsection.

An altemative and general embodiment is comprised of a system corresponding to only a portion of the operator computer system containing i/o module 104 for obtaining eligible orders to trade combinations of financial instruments, and matching module 108 to accept the obtained orders or expanded eligible orders as input and to process said obtained orders to obtain and output a matched collection of expanded eligible orders (or output the collection of eligible orders corresponding to said matched collection).

Another alternative and general embodiment is comprised of a computer-readable medium storing software capable of rendering a system operative to implement i/o module 104 and matching module 108, so that said system (as in previous paragraph) may obtain expanded eligible orders (or eligible orders) as input and output a matched collection of expanded eligible orders (or output the collection of eligible orders corresponding to said matched collection).

### Combinatorial Matching Algorithms

Algorithms will be described with the aid of various collections of expanded eligible orders that exist in an abstract sense or when under consideration (but could be empty unless expressely stated otherwise). Thus, when introducing, defining, constructing, manipulating, modifying, or otherwise using said collections, there may not be a need to physically create or move data to accomplish such usage (e.g. the phrase “remove orders x and y from collection C” does not necessarily imply or require that collection C be created or represented in memory by duplicating, from all stored eligible orders, those eligible orders that must be in C, and then accomplishing the removal by deleting x and y from memory). One skilled in the art will readily be able, if necessary, to efficiently access, construct, modify, manipulate, represent, or otherwise use such collections by appropriate use of arrays, vectors, pointers, data structures, classes, databases or other commonly used techniques and structures in programming or software engineering.

An algorithm may be deterministic or non-deterministic, and orderings (or sub-algorithms) used by an algorithm may be adaptive (varying with state of algorithm, as algorithm progresses) or fixed (do not vary with state of algorithm). Analogously, collections may be fixed or may vary with time or wfith a point in the execution of an algorithm, method, or other process.

An “irreducible matching collection” is a matching collection of expanded eligible orders for which no subcollection is a matching collection of expanded eligible orders.

The “genus” of a CMA is the maximum size of an irreducible matching collection that can be found by a simplified version of said CMA, wherein said simplified version is obtained from said CMA by removing any step or portion of said CMA that checks a number of possible collections of expanded eligible orders to see if any collection in said possible collections is a matching collection, wherein the check is not fundamental to the operation of the algorithm. Some examples, whose meaning will be more easily understood after reading the descriptions of a forward matching algorithm (FMA) and a reverse elimination algorithm (REA) below, are: an REA always checks its input because such a check is fundamental to the operation of an REA, thus the genus of an REA is maximal because any irreducible matching collection input to said REA will be checked immediately and found to be a matching collection; and the genus of an FMA accepting eligible orders of the all or none execution type is not necessarily maximal, and it should be noted that adding a step to an FMA to check its input to see if said input is a matching collection would not be a step that is fundamental to an FMA.

The CMA used in an embodiment may be based on a search of a combinatorial tree corresponding to the collection of expanded eligible orders (or to the equivalent collection of eligible orders). Such a combinatorial tree would normally be structured so that the first level corresponds to the entire collection, the second level is comprised of subcollections of said collection that have one less member than said collection, the third level is comprised of subcollections of said collection that have two less members of said collection, and so on until the last level that is comprised of subcollections of said collection that have only two members (there is no need to consider another level with only one member per subcollection since no such subcollection can be a matching subcollection). A level of the tree may or may not have an ordering on the subcollections that comprise said level. Such a search proceeds until a termination condition(s) is met or until a satisfactory matching subcollection is found. Said CMA could base said search on a pruning heuristic, and some examples of such a heuristic are: a backtracking search, a beam search, a best-first search, a breadth-first search, a depth-first search, a depth-limited search, an iterative deepening depth-first search, and a uniform cost search.

The preferred CMA is based on a preferred forward matching algorithm (FMA), a preferred reverse elimination algorithm (REA), and one or more integer programming solvers (IPS) such as CPLEX or LP_solve. Said preferred CMA will execute these algorithms (each preferred FMA, preferred REA, and said integer programming solvers) and choose the best matching collection output by said algorithms as the matched collection to be output by said preferred CMA. A possible variation is to select a subcollection of expanded eligible orders consisting of those orders having a number of legs less than or equal to nl-1, then processing said subcollection with said algorithms and comparing the outputs of said algorithms with the previous outputs of said algorithms, choosing the best matching collection found by said algorithms. Said CMA may repeat this process with nl-2, nl-3, and so forth, or it may use an analogous process with nq-1, nq-2, and so forth, or with both nl-1, nq-1; nl-2, nq-2; nl-1, nq-2; and so forth. One skilled in the art will appreciate that said preferred CMA or said algorithms could be executed in sequentially or preferably in parallel, and that a computer having a multi-core processor (or multiple processors) or a computer cluster would be an ideal system on which to execute such algorithms.

It will be helpful to now introduce and explain the following phrases and subcollections of the collection of expanded eligible orders used by the preferred CMA:
i) current candidates collection (CCC): orders currently available for matching;
ii) current tentative collection (CTC): orders currently being used in an attempt to construct a matching collection;
iii) current matched collection (CMC): orders that (together) have been determined to form a matching collection and no longer available for matching;
iv) current discarded collection (CDC): orders that have been discarded by an FMA and no longer available for matching;
v) initial selection scheme (ISS): a sub-algorithm of an FMA, used to choose one or more orders from the CCC that will initially form the CTC;
vi) priority selection scheme (PSS): a sub-algorithm of an FMA, used to choose one or more orders from the CCC that will be added to the CTC in an attempt to find a matching collection;
vii) priority elimination scheme (PES): a sub-algorithm of an REA, used to choose one or more orders to remove from the CCC in an attempt to find a matching collection;
viii) special selection scheme (SSS): a sub-algorithm of a PES, used to choose one order from the CPC, the CEC, or the CIC;
ix) current imbalance vector (CIV): the column vector obtained by either (in context of an FMA) summing all n-tuples (as column vectors) corresponding to orders in the CTC, then multiplying the resulting column vector by −1 to obtain the CIV, or (in context of an REA) by summing all n-tuples (as column vectors) corresponding to orders in the CCC to obtain the CIV;
x) if CIVᵢ>0 then the financial instrument corresponding to index i has a current “buy trade imbalance”, if CIVᵢ<0 then said instrument has a current “sell trade imbalance”, and if CIVᵢ=0 then said instrument has no corresponding trade imbalance;
xi) current imbalance collection (CIC): orders in the CCC for which each leg corresponds to a respective financial instrument, with respective index i, such that the i-component of the CIV is non-zero;
xii) current unmatchable collection (CUC): orders in the CCC that have a leg corresponding to a financial instrument which has no other associated buy or sell quantities;
xiii) current preferred collection (CPC): orders in the CCC for which each non-zero generalized leg quantity, corresponding to a respective index i, is of the same sign as the i-component of the CIV and such that the absolute value of said generalized leg quantity is less than or equal to the absolute value of said i-component (thus the CPC consists of every x in the CCC satisfying, for all i such that xi is non-zero, SGN(xᵢ)=SGN(CIVᵢ) and |xᵢ|<=|CIVᵢ|, where here SGN() is the sign function: SGN(z)=−1 if z<0 or SGN(z)=1 if z>0);
xiv) in respect of a financial instrument having a current trade imbalance, the buy quantities corresponding to orders in the CPC will be called “preferred buy quantities”, and the sell quantities corresponding to orders in the CPC will be called “preferred sell quantities”; and
xv) current expanded collection (CEC): every x in the CCC for which there exists at least one index i such that xᵢ is non-zero, SGN(xᵢ)=SGN(CIVᵢ) and |xᵢ|<=|CIVᵢ|; a leg of x corresponding to an index k (xₖ non-zero) for which SGN(xₖ) is not equal to SGN(ClVₖ) or for which |xₖ|>|CIVₖ| is called an “outside leg” of x.

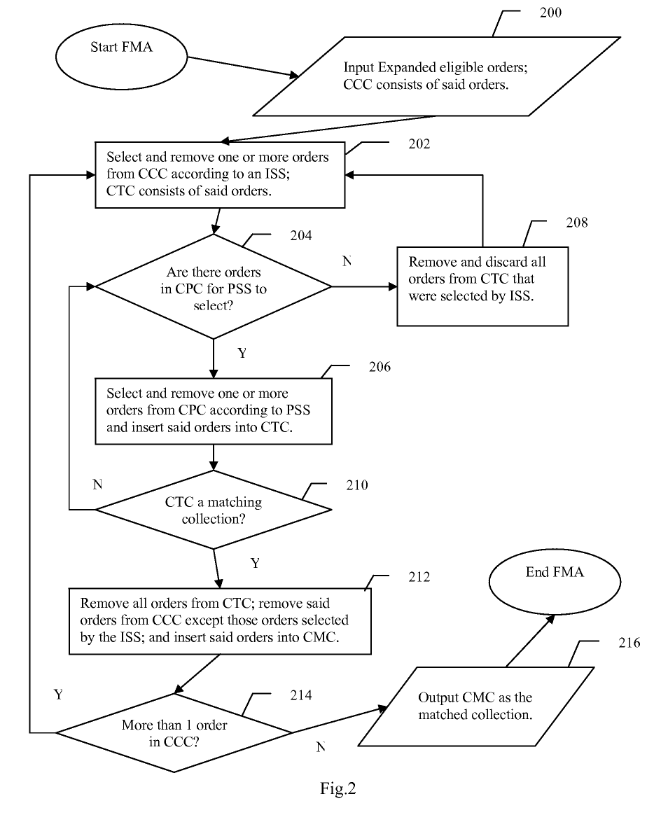

FIG. 2 illustrates an FMA as a flowchart. In step 200, expanded eligible orders are input to said FMA and the CCC consists of said expanded eligible orders. Step 202 is to select and remove one or more orders from the CCC according to an ISS, and to consider the CTC as consisting of said orders. In step 204, determine if there are any orders in the CPC available for a PSS to select; if there exist such orders then proceed to step 206, otherwise proceed to step 208. In step 208, remove and discard all orders from the CTC that were selected by the ISS. In step 206, select and remove one or more orders from the CPC according to the PSS, and insert said one or more orders into the CTC. In step 210, check if the CTC is a matching collection; if the CTC is not a matching collection then return to step 204, otherwise proceed to step 212. In step 212, remove all orders from CTC, also remove said all orders from the CCC except those orders that were selected by the ISS (and thus already removed from the CCC), and insert said all orders into the CMC. In step 214, check if there is more than 1 order in the CCC; if there is not more than 1 order then proceed to step 216, otherwise return to step 202. In step 216, output the CMC as the matched collection of expanded eligible orders. A preferred FMA is obtained from a preferred ISS and a preferred PSS. (It should be emphasized that subcollections of a collection of orders are considered in an abstract sense as a set, separate from said collection; thus, removal of orders from said subcollection does not imply removal from said collection.)

The preferred ISS selects one order from the CCC. To select an order, said ISS first considers those orders (represent said orders as a subcollection S₁) in the CCC that correspond to eligible orders having a minimal number of fills. If S₁ consists of one order then said ISS selects said one order from the CCC, otherwise said ISS then considers those orders (S₂) among S₁ having a maximal number of legs. If S₂ consists of one order then said ISS selects said one order from the CCC, otherwise said ISS then considers those orders (S₃) among S2 for which the sum of the absolute value of each generalized leg quantity is maximal (if x is in S₃ then TT(x)>=TT(y) for any y in S₂). If S₃ consists of one order then said ISS selects said one order from the CCC, otherwise said ISS randomly selects an order from S₃.

The preferred PSS selects one order from the CPC if said CPC is non-empty. To select an order, said PSS first considers those orders (S₁) in the CPC for which the sum of the absolute value of each generalized leg quantity is maximal. If S₁ consists of one order, then said PSS selects said one order from the CPC, otherwise said PSS considers those orders (S₂) among S₁ having a maximal number of legs. If S₂ consists of one order, then said PSS selects said one order from the CPC, otherwise said PSS randomly selects an order from S₂.

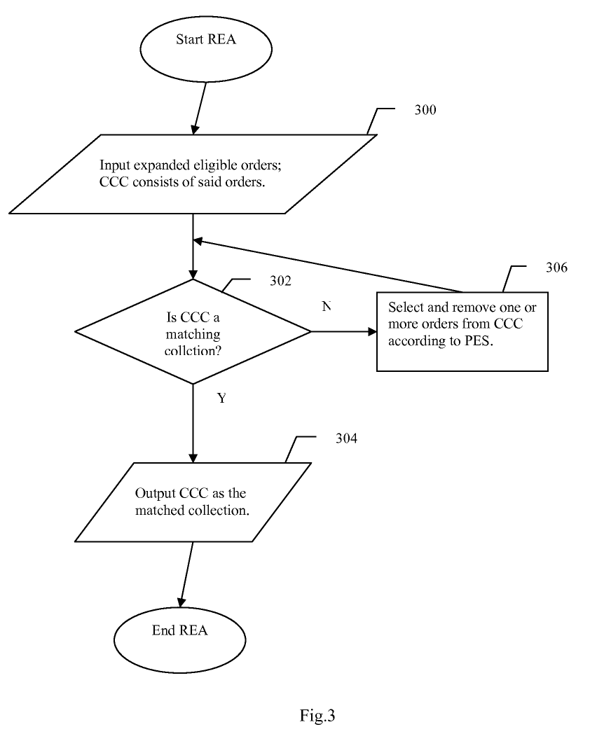

FIG. 3 illustrates a REA as a flowchart. In step 300, expanded eligible orders are input to said REA and the CCC consists of said expanded eligible orders. In step 302, determine if the CCC is a matching collection; if the CCC is matching collection then proceed to step 304, otherwise proceed to step 306. In step 304, output the CCC as the matched collection of expanded eligible orders. In step 306, select and remove one or more orders from the CCC according to the PES. A preferred REA is obtained from a preferred PES which will be described below.

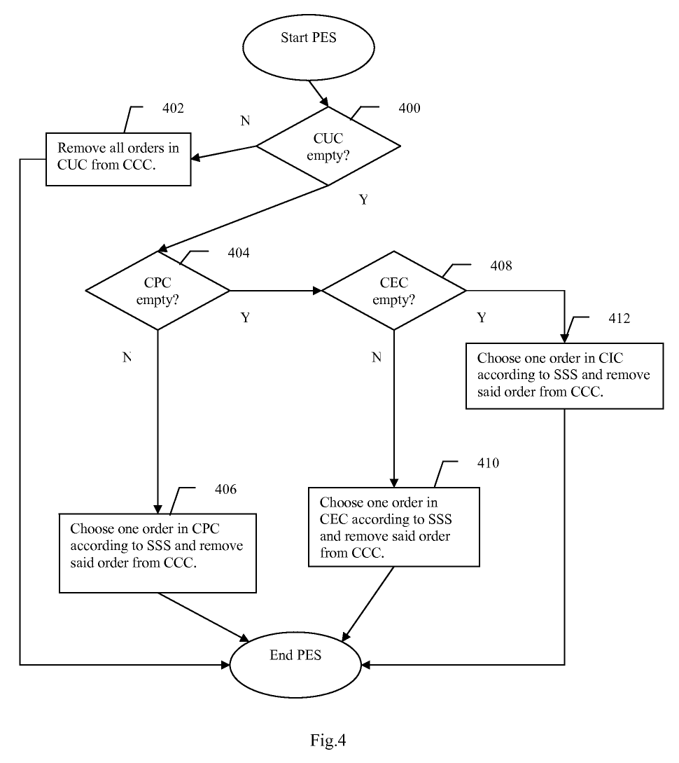

A preferred PES is illustrated in FIG. 4 as a flowchart, and invokes an SSS described below. In step 400, said PES checks if the CUC is empty; if the CUC is non-empty then proceed to step 402, otherwise proceed to step 404. In step 402, said PES removes all orders that are in the CUC from the CCC and terminates. In step 404, said PES checks if the CPC is non-empty; if the CPC is non-empty then proceed to step 406, otherwise proceed to step 408. In step 406, said PES invokes (executes) an SSS that chooses one order from the CPC, then said PES removes said order from the CCC and terminates. In step 408, said PES checks if the CEC is non-empty; if the CEC is non-empty, then proceed to step 410 otherwise proceed to step 412. In step 410, said PES invokes said SSS that chooses one order from the CEC, then said PES removes said order from the CCC and terminates. In step 412, said PES invokes said SSS that chooses one order from the CIC, then said PES removes said order from the CCC and terminates.

Said SSS may be thought of as one algorithm or several algorithms. It may run and terminate each time it is invoked or it may remain running after first invocation or after the preferred CMA begins and await directions from said PES. When choosing an order from the CPC, said SSS first selects the subset of Fl consisting of all financial instruments having a trade imbalance, then imposes a preferred priority ordering on said subset and chooses an order from a selected subcollection (described below) of the CPC using said preferred priority ordering to determine said subcollection. Said order may be chosen analogously to how the preferred PSS chooses orders except that orders are chosen from said subcollection instead of from the CPC.

A preferred priority ordering is based on a positive integer k and a respective ordering on k-tuples associated with each index, wherein said respective ordering is either the supremum ordering or the infimum ordering, wherein said priority ordering associates a respective k-tuple of selected numbers to each considered financial instrument, and wherein said priority ordering is the standard priority ordering. Optionally, k is equal to two, the ordering associated with first index is the supremum ordering and the ordering associated with the second index is the infimum ordering, wherein the associated 2-tuple, in respect of each considered financial instrument, has first component equal to the smallest of the buy quantities and the absolute sell quantities, and has second component equal to the sum of the number of buy quantities and the number of sell quantities. Said subcollection consists of those orders in the CPC having a respective non-zero generalized leg quantity corresponding to a financial instrument having maximal priority in said subset according to said priority ordering.

When choosing an order from the CIC, said SSS may operate in an analogous manner to how it operates when choosing an order from the CPC, except that orders are of course chosen from the CIC instead of from the CPC. When choosing orders from the CEC, said SSS may operate in an analogous manner to how it operates when choosing orders from the CPC, except that any order in said selected subcollection must have a minimal number of outside legs, and orders are chosen from the CEC instead of from the CPC.

At any point during execution of a CMA (or even before a CMA is started), a market maker for an embodiment may be informed of the state of the processing of the input to said CMA (or informed of the current collection E of eligible orders or current collection EO of expanded eligible orders) and may respond with an order(s) that makes the CTC or the CCC (or the E or EO) a matching collection in which case the order may be accepted as eligible and the corresponding expanded eligible orders included into the CTC or CCC respectively. However, it will be assumed that the input to a CMA consists of more than one order because otherwise the input cannot be matched; if there is one order the market maker may be consulted without executing said CMA.

Some further embodiments of the invention will now be summarily described, including some that have already been described. An embodiment, corresponding to claim 1, was described in the summary section and that description is repeated here for the purpose of convenient reference.

In one embodiment, a method of trading combinations of financial instruments is provided. Combination orders to trade financial instruments are obtained by receiving such orders during a first selected time period. The received orders that are eligible for matching are stored and the corresponding expanded eligible orders are processed by a combinatorial matching algorithm (CMA) beginning at a selected time. The output of said CMA is a matched collection of expanded eligible orders that the operator of the embodiment may consider to be executed. Eligibility is prescribed by requiring an eligible order to satisfy at least one selected condition. The preceding sentence should be interpreted as meaning that an order is eligible if. said order satisfies all conditions in a non-empty group of selected necessary conditions, wherein said group includes the condition that all the financial instruments specified by the legs of an eligible order must be in a set of two or more financial instruments that have been selected to be made available for trading.

Other embodiments, having all of the characteristics said one embodiment, include embodiments wherein a termination condition of said CMA is one the following: a second selected time has passed; a selected period of time has elapsed since the time selected in said basic embodiment; said CMA discovers a matching collection of expanded eligible orders containing a percentage of selected expanded eligible orders that is greater than or equal to a selected number; and said CMA discovers a matching collection of expanded eligible orders for which the matching score of a selected matching problem is greater than or equal to a selected number.

In another embodiment, having all the characteristics of said one embodiment, said CMA is based on an algorithm that solves a selected matching problem, where said problem is a type of combinatorial optimization problem. An optional feature of said another embodiment includes an embodiment for which said algorithm is based on a combinatorial optimization heuristic, where a further optional feature is that said heuristic is based on one of the following: an artificial neural network, an evolutionary algorithm, a hill climbing heuristic, a greedy hill climbing heuristic, a genetic algorithm, a tabu search heuristic, a quantum annealing heuristic, a simulated annealing heuristic, and an exhaustive search heuristic.

Optional features of said another embodiment include embodiments for which said algorithm has one of the following characteristics: said algorithm is a commercially available integer programming solver; said algorithm is a freely available integer programming solver; and said algorithm is based on one of the following techniques that can be used to solve integer programming problems: dynamic programming, branch and bound, column generation, constraint programming, cutting planes, Lagrangian relaxation, linear programming relaxation, and surrogate relaxation. Other optional features of said another embodiment include embodiments for which said CMA is based on one of the following types of algorithms that can be used to solve various integer programming problems: a core algorithm, a discrete convolution algorithm, an evolutionary computation algorithm, and a word ram algorithm.

Other optional features of said one embodiment include embodiments having one or more characteristics that increase, at least in principle, the quality of the output of said CMA, where said characteristics include: said selected time follows the conclusion of said first selected time period; said CMA executes a plurality of algorithms, wherein each algorithm in said plurality takes the expanded eligible orders as input and outputs a respective matching collection of expanded eligible orders, and wherein the output of said CMA is equal to the output of one selected algorithm in said plurality; said CMA, upon completing a preliminary processing of expanded eligible orders but before producing output, reprocesses a selected collection of expanded eligible orders; said group includes one of the following necessary conditions: the order quantity of an eligible order must be less than or equal to a selected number, the order quantity of an eligible order multiplied by the sum of the leg quantities of said eligible order must be less than or equal to a selected number, the number of legs of an eligible order must be less than or equal to a selected number, each leg quantity of an eligible order that allows partial fills must be less than or equal to a selected number, and each leg quantity of an eligible order of the all or none execution type multiplied by the order quantity of said eligible order must be less than or equal to a selected number; said at least one selected condition includes one of the following necessary conditions: said group includes the necessary condition that an eligible order must allow partial fills; said group includes the necessary condition that an eligible order must not specify a limit price; to each financial instrument in said set is associated a respective number, wherein said group includes the necessary condition that an eligible order having a leg specifying a quantity of said each financial instrument to buy or sell, said quantity must be less than or equal to said respective number; the number of financial instruments in said set is less than a selected number; at least a part of said CMA runs on a quantum computer; and providing information on the state of said processing to at least one market maker for said method, receiving zero or more combination orders to trade financial instruments from said at least one market maker during a selected third time period, and determining whether to accept a received combination order from said market maker as an eligible order.

Other optional features of said one embodiment include embodiments having one or more characteristics that provide additional trading functionality, where said characteristics include: accepting modification orders during a second selected time period, where a modification order is a directive from a trader to either cancel or to both cancel and replace an order that was previously received from said trader; said second selected time period is substantially the same as said first selected time period; receiving per unit prices at which the financial instruments in said set are to be traded in respect of executed orders; informing users of said method of said per unit prices; said group includes the necessary condition that an eligible order specifying a limit price must be such that an execution of said eligible order at an execution price computed using the received prices would not violate the limit price constraint of said eligible order; said group includes the necessary condition that an order satisfy selected credit requirements; performing one of the following based on a respective price per unit of each financial instrument in said set that is traded in respect of executed orders: clearing trades in said each financial instrument, and settling trades in said each financial instrument; informing a respective party of the respective quantity of each eligible order filled, wherein said respective party is the respective sender or the respective trader associated with said each eligible order; providing, at selected times, market depth information to users of said method, or providing, on a real-time basis, market depth information to users of said method; periodically performing said method; periodically performing said method wherein each financial instrument in said set is traded during respective regular trading hours on each respective regular trading day at a respective trading venue that operates so as to facilitate the process of price discovery in said each financial instrument, wherein said method is performed on selected days after DMTM prices of said financial instruments have been determined, and wherein said set is comprised of selected options on at least one underlying financial instrument; and receiving at least one list of financial instruments, wherein each financial instrument in said set is selected from said at least one list.

In yet another embodiment, having all of the characteristics of said one embodiment, said CMA is based on a forward matching algorithm. Optional features of said yet another embodiment include embodiments having one of the following characteristics: the initial selection scheme, in respect of each considered expanded eligible order, is based on one of the following numbers: the order quantity, the number of legs, and the generalized leg quantities; the initial selection scheme or the priority selection scheme is based on random selection; if the number of orders in the current preferred collection is less than or equal to a selected number then the priority selection scheme performs an exhaustive search with respect to the current preferred collection; and the initial selection scheme selects expanded eligible orders from the collection consisting of expanded eligible orders in the current candidate collection having a minimal number of fills.

In another embodiment, having all the characteristics of said one embodiment, said CMA is based on a reverse elimination algorithm. Optional features of said another embodiment include embodiments having one of the following characteristics: the priority elimination scheme is based on random selection; the priority elimination scheme, in respect of each considered expanded eligible order, is based on one of the following numbers: the order quantity, the number of legs, and the generalized leg quantities; if the number of orders in the current preferred collection is less than or equal to a selected number then the priority elimination scheme performs an exhaustive search with respect to the current preferred collection; the priority elimination scheme is based on a current imbalance vector; the priority elimination scheme, when the current unmatchable collection is non-empty, chooses all orders in the current unmatchable collection; the priority elimination scheme, when the current preferred collection is non-empty, chooses orders in a non-empty selected subcollection of the current preferred collection; when the current preferred collection is non-empty, imposing a priority ordering on a selected subset of said set, wherein each financial instrument in said subset has a current trade imbalance, and wherein each order in said selected subcollection has a respective non-zero generalized leg quantity corresponding to a financial instrument having maximal priority in said set; said CMA solves a selected linear matching problem, wherein the priority elimination scheme, when the current preferred collection is non-empty, chooses one order in the current preferred collection, wherein the matching score associated with said one order is minimal in the current preferred collection; the priority elimination scheme, when the current preferred collection is empty, chooses one order in the current imbalance collection; the priority elimination scheme, when the current preferred collection is empty and the current expanded collection is non-empty, chooses one order in the current expanded preferred collection, and wherein the number of outside legs of said one order is minimal in the current expanded collection.

In a further embodiment, having all of the characteristics of said another embodiment, the priority elimination scheme is based on a priority ordering imposed on a selected subset of said set. Optional features of said further embodiment include embodiments having one of the following characteristics: said priority ordering, in respect of each financial instrument in said subset, is based on one of the following numbers: the buy quantities, and the sell quantities; said priority ordering is based on a positive integer k and a respective ordering on k-tuples associated with each index, wherein said respective ordering is either the supremum ordering or the infimum ordering, wherein said priority ordering associates a respective k-tuple of selected numbers to each considered financial instrument, and wherein said priority ordering is the standard priority ordering; said k is equal to one, wherein the ordering associated with the first index is the supremum ordering, wherein the associated 1-tuple, in respect of each considered financial instrument, has first component equal to the maximum of the average buy quantity and the average absolute sell quantity; said k is equal to one, wherein the ordering associated with the first index is the infimum ordering, wherein the associated 1-tuple, in respect of each considered financial instrument, has first component equal to the sum of the number of buy quantities and the number of sell quantities; said k is equal to two, wherein the ordering associated with first index is the supremum ordering and the ordering associated with the second index is the infimum ordering, wherein the associated 2-tuple, in respect of each considered financial instrument, has first component equal to the smallest of the buy quantities and the absolute sell quantities, and has second component equal to the sum of the number of buy quantities and the number of sell quantities.

Although the present invention has been described in considerable detail with reference to certain preferred and alternative embodiments thereof, other embodiments are possible. It will be apparent to those of ordinary skill in the art that various modifications may be made without departing from the spirit and scope of the invention, where said modifications include: variations in size, materials, shape, form, configuration, environment, function and manner of operation, assembly and use. As an example, any claimed or described embodiment herein can be easily adapted to obtain other embodiments which can accept an order(s) having a leg specifying to buy or sell a financial instrument f in a quantity that is a rational number c/d, where 1/d is the minimum quantity of said instrument that may be traded: simply create/consider a virtual financial instrument g such that 1 unit of g equals 1/d units of f and the leg is then equivalent to buy or sell c units of g (c is a positive integer by definition). The spirit and scope of the appended claims should not be limited to the description of the preferred embodiments or the description of other embodiments herein.

What is claimed is:

1. A computer-implemented method for trading combinations of financial instruments, said method comprising:
receiving, during a selected time period, combination orders to trade financial instruments;
storing each eligible received combination order, wherein a received combination order is eligible if it satisfies at least one selected condition, wherein said at least one selected condition includes the necessary condition that all financial instruments specified by the legs of an eligible order are in a set of two or more selected financial instruments; and
processing eligible orders or expanded eligible orders with a combinatorial matching algorithm (CMA), wherein said processing begins at a selected time.

2. The method of claim 1, wherein the genus of said CMA is greater than two.

3. The method of claim 1, wherein said CMA is based on a search of a combinatorial tree corresponding to the expanded eligible orders.

4. The method of claim 3, wherein said search is based on a pruning heuristic.

5. The method of claim 1, wherein said CMA is based on an algorithm that solves a selected matching problem.

6. The method of claim 5, wherein said algorithm is based on a combinatorial optimization heuristic.

7. The method of claim 5, wherein said selected matching problem is linear, and wherein said algorithm is based on an algorithm that solves an integer programming problem.

8. The method of claim 7, further comprising selecting a collection of expanded eligible orders, wherein the matching score for each order in said collection is equal to one of the following: a respective number; and the sum of the absolute values of the respective generalized leg quantities.

9. The method of claim 1, further comprising receiving, for each financial instrument in said set, a respective price per unit at which said each financial instrument may be traded, wherein said CMA satisfies one of the following conditions: said CMA is not constrained by limit prices and said each financial instrument in a selected subset of said set may not be traded at a price per unit other than said respective price; and said CMA is constrained by limit prices and uses the received prices to determine if a subcollection of expanded eligible orders containing limit orders is a matching collection satisfying the limit price constraints of said orders.

10. The method of claim 1, wherein said at least one selected condition includes one of the following necessary conditions: an eligible order must allow partial fills; an eligible order must not specify a limit price; the order quantity of an eligible order must be less than or equal to a selected number; the order quantity of an eligible order multiplied by the sum of the leg quantities of said eligible order must be less than or equal to a selected number; the number of legs of an eligible order must be less than or equal to a selected number; each leg quantity of an eligible order that allows partial fills must be less than or equal to a selected number; each leg quantity of an eligible order of the all or none execution type multiplied by the order quantity of said eligible order must be less than or equal to a selected number; and to each financial instrument in said set is associated a respective number such that for each eligible order having a leg specifying a quantity of said each financial instrument to buy or sell, said quantity must be less than or equal to said respective number.

11. The method of claim 1, wherein each financial instrument in said set is one of the following: a respective derivative; a respective stock; a respective futures contract; a respective currency pair; and a respective option.

12. The method of claim 1, further comprising periodically performing said method, wherein each financial instrument in said set is traded during respective regular trading hours on each respective regular trading day at a respective trading venue that operates so as to facilitate the process of price discovery in said each financial instrument, wherein said method is performed on selected days after DMTM prices of said financial instruments have been determined, and wherein said set is comprised of a financial instrument and selected options on said financial instrument.

13. The method of claim 1, further comprising one of the following: computer-executable software, transmitted as an information signal, for causing a computer to implement the steps of said method; and a computer-readable medium having computer-executable instructions stored thereon for causing a computer to implement the steps of said method.

14. A computer-implemented method for trading combinations of financial instruments, said method comprising:
receiving, during a first selected time period, combination orders to trade financial instruments;
storing each eligible received combination order, wherein a received combination order is eligible if it satisfies at least one selected condition, wherein said at least one selected condition includes the necessary condition that all financial instruments specified by the legs of an eligible order are in a set of two or more selected financial instruments; and
processing eligible or expanded eligible orders with a combinatorial matching algorithm (CMA), wherein said processing begins at a selected time, wherein said CMA is not constrained by limit prices, and wherein said CMA is based on one of the following: a forward matching algorithm (FMA), and a reverse elimination algorithm (REA).

15. The method of claim 14, wherein said CMA is based on one of the following: a FMA whose corresponding initial selection scheme, in respect of each considered expanded eligible order, is based on one of the following numbers: the order quantity, the number of legs, and the generalized leg quantities; and an REA whose corresponding priority elimination scheme, in respect of each considered expanded eligible order, is based on one of the following numbers: the order quantity, the number of legs, and the generalized leg quantities.

16. The method of claiml4, wherein said CMA is based on one of the following: a FMA having a priority selection scheme that selects orders from the current preferred collection; a FMA having an initial selection scheme that selects expanded eligible orders from the collection consisting of expanded eligible orders in the current candidate collection having a minimal number of fills; and a FMA having priority selection scheme that performs an exhaustive search with respect to the current preferred collection if the number of orders in said collection is less than or equal to a selected number.

17. The method of claim 14, wherein said CMA is based on a REA whose corresponding priority elimination scheme (PES) has one of the following characteristics: said PES is based on a priority ordering imposed on a selected subset of said set; said PES is based on the components of a current imbalance vector; and said PES performs an exhaustive search with respect to the current preferred collection if the number of orders in said collection is less than or equal to a selected number.

18. The method of claim 14, wherein said CMA is based on a REA, and further comprising imposing a priority ordering on a selected subset of said set, wherein said priority ordering is based on one of the following: a buy quantity; a sell quantity; a positive integer k and a respective ordering on k-tuples associated with each index, wherein said respective ordering is either the supremum ordering or the infimum ordering, wherein said priority ordering associates a respective k-tuple of selected numbers to each considered financial instrument, and wherein said priority ordering is the standard priority ordering.

19. The method of claim 14, wherein the priority elimination scheme, when the current preferred collection is non-empty, chooses orders in a non-empty selected subcollection of the current preferred collection, wherein said subcollection is determined by imposing a priority ordering on a selected subset of said set, wherein each financial instrument in said subset has a current trade imbalance, and wherein each order in said subcollection has a respective non-zero generalized leg quantity corresponding to a financial instrument having maximal priority in said subset.

20. The method of claim 14, wherein said CMA is based on a REA, and wherein the associated priority elimination scheme (PES) has one of the following characteristics: said PES chooses all orders in the current unmatchable collection when the current unmatchable collection is non-empty, said PES chooses orders in a non-empty selected subcollection of the current preferred collection when the current preferred collection is non-empty, said PES chooses one order in the current imbalance collection when the current preferred collection is empty, and said PES, when the current preferred collection is empty and the current expanded collection is non-empty, chooses one order in the current expanded collection wherein the number of outside legs of said one order is minimal in the current expanded collection.

21. The method of claim 14, further comprising accepting, during said first selected time period, modification orders, wherein each such modification order is a directive from a sender to either cancel or to both cancel and replace a prior order that was received from said sender; further comprising informing the respective sender or the respective trader associated with each eligible order of the respective quantity of said each eligible order filled; further comprising providing information on the state of said processing to at least one market maker for said method; further comprising receiving zero or more combination orders to trade financial instruments from said at least one market maker during a second selected time period; further comprising determining whether to accept a received combination order from said market maker as an eligible order; wherein said CMA is a preferred CMA; wherein said preferred CMA solves a linear selected matching problem; wherein the matching score for any expanded eligible order is equal to one; wherein said selected time follows the conclusion of said first selected time period; wherein the number of financial instruments in said set is less than a first selected number; and wherein said at least one selected condition includes all of the following necessary conditions: the order quantity of an eligible order multiplied by the sum of the leg quantities of said eligible order is less than or equal to a second selected number, the number of legs of an eligible order is less than or equal to a third selected number, each leg quantity of an eligible order is less than or equal to a fourth selected number, an eligible order must allow partial fills, and an eligible order must not specify a limit price.

22. A computer-implemented method for trading combinations of financial instruments, said method comprising: steps for obtaining combination orders to trade financial instruments; and steps for obtaining a matched collection of expanded eligible orders, wherein an obtained combination order is eligible if it satisfies at least one selected condition, and wherein said at least one selected condition includes the necessary condition that all financial instruments specified by the legs of an eligible order are in a set of two or more selected financial instruments.

23. A computer-based system for trading combinations of financial instruments, said system comprising: means for obtaining combination orders to trade financial instruments; and means for obtaining a matched collection of expanded eligible orders, wherein an obtained order is eligible if it satisfies at least one selected condition, and wherein said at least one selected condition includes the necessary condition that all financial instruments specified by the legs of an eligible order are in a set of two or more selected financial instruments.

24. The system of claim 23, further comprising means and steps for increasing, at least in principle, the quality of said matched collection.

25. The system of claim 23, further comprising means and steps for providing additional trading functionality.
